(19) United States
(12) Patent Application Publication
(10) Pub. No.: US 2006/0080702 A1
(43) Pub. Date: Apr. 13, 2006

(54) Systems and methods for delivering content over a network

(75) Inventors: Eric Diez, Atlanta, GA (US); Blake P. Lewin, Lilburn, GA (US); Miomir Arandelovic, Powder Springs, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Turner Broadcasting System, Inc.

(21) Appl. No.: 11/220,468

(22) Filed: Sep. 7, 2005

Related U.S. Application Data
(63) Continuation-in-part of application No. 10/850,899, filed on May 20, 2004.
(60) Provisional application No. 60/675,385, filed on Apr. 26, 2005.

(51) Int. Cl. H04N 7/16; H04N 7/167

(52) U.S. Cl. 725/30; 725/28; 725/31; 725/25

(57) ABSTRACT

A content delivery system that uses a graphical user interface to introduce users to and allow them to select from available content. A game delivery system that uses game players, such as emulators, to execute software written to run on a plurality of game platforms. The systems include a scalable, dynamic interface that launches and manages game players in a manner that is largely transparent to the user, and a combination of linear and on-demand content provides users with a managed gaming experience not unlike that of interactive television. In addition, the system includes a graphical user interface for allowing a primary user of an account to set user-specific controls for one or more users listed on the account.

### CROSS REFERENCE TO RELATED APPLICATIONS

This application claims priority from provisional U.S. Application No. 60/675,385 entitled “Systems and Methods For Delivering Content Over a Network,” which was filed on Apr. 26, 2005 and which is hereby incorporated by reference in its entirety, pending non-provisional U.S. application Ser. No. 10/850,899 entitled “Systems and Methods for Delivering Content Over a Network,” which was filed on May 20, 2004 and which is hereby incorporated by reference in its entirety, and pending U.S. Design patent application Ser. No. 29/228,581 entitled “User Interface for a Display Screen,” which was filed on Apr. 26, 2005 and which is hereby incorporated by reference in its entirety.

### FIELD OF THE INVENTION

The present invention relates generally to entertainment distribution systems and methods and specifically describes systems that deliver games to users over a network.

### BACKGROUND

The U.S. entertainment software industry is almost a $7 billion a year industry, according to the most recent data released by the Interactive Digital Software Association (now the Entertainment Software Association). More than 221 million computer and video games are sold each year, which equates to almost two games for every household in America. The bulk of the entertainment software market share has historically been devoted to games written for personal computers. But in recent years the introduction of specialized video game consoles by companies such as Sony, Microsoft, and Sega has caused console software to capture a greater percentage of the market share.

Not surprisingly, the competition for the gaming dollar has been fierce. Every few years improved versions of the specialized gaming platforms are released, offering increased processing speeds and graphic capabilities. Soon after an improved version of a video game console is released, and many times even before the release, the companies that write the software for the consoles abandon the older console version and begin developing games for the newer console. While games are typically available for older gaming platforms, the bulk of new games that come to market are always written for the latest gaming systems.

Another aspect of the competition between manufacturers of gaming systems is the release of game content that is exclusive to a single game platform. One technique game manufacturers have used in recent years to build or maintain market share is to develop a game or a game series that is only available on the game system sold by that manufacturer. Games are often developed by companies that are independent of the game platform manufacturers, and these companies write games (or port them) so that the game can be played on a number of different systems. The advantage to the game developer, of course, is that by marketing a game to those gamers that own different gaming systems, the developer reaches a larger target audience. But the developer of an exclusive game has a slightly different motivation. Typically, a game that is developed or marketed for a single platform is purposely limited to that platform in an effort to convince consumers to buy the gaming system. Examples of exclusive game content include the Sonic™ series from Sega and Halo™ from Microsoft.

From the perspective of the gamer, the presence of multiple competing gaming systems and exclusive content written for each is both good and bad. On one hand, the competition between manufacturers forces them to strive to improve the capabilities of their respective gaming systems. But on the other hand, the presence of multiple, incompatible gaming systems, forces the gamer to choose between different sets of available games or, alternatively, requires that the gamer purchase two or more of the competing gaming systems. Between the cost of updating to the latest gaming platforms and the cost of the actual game software, it quickly becomes cost prohibitive for an enthusiast that wants to play games written for two or more incompatible gaming systems.

Emulation software (sometimes referred to herein as “emulators”) is well known. Generally, a software emulator is a computer program that runs on a target platform (often a personal computer) and uses software to supply original platform capabilities that are not present in the target platform. For example, a software emulator written to emulate a Sega Genesis™ console device uses software to perform some or all of the specialized graphic functions that the Sega Genesis™ console device would normally perform. Similarly, the emulator uses software code to emulate the hardware and operation system (OS) configuration within the Sega Genesis™ console device and translates the game software requests into requests that are handled by the hardware configuration of the target platform. Other emulators are configured to interpret machine code blocks and execute the instructions using equivalent functions written in a higher level language, such as C, and some emulators are configured to both interpret and translate machine code blocks written to run on the original platform.

The benefit of emulators is that the application allows the gamer to play games on his or her system that were not originally written for that type of system. But a downside of emulators is that they are notoriously difficult to write (requiring a large amount of knowledge of the internal workings of the system that is being emulated) and even a well-written emulator will not emulate every game written for the emulated system. Another problem with emulators is the difficulty in making the emulator work properly with the end-user computing device on which the emulator is running.

An unsatisfied need therefore exists in the industry for new systems and methods of delivering game content to users that was written for different gaming platforms. A related need is for an interface that is user-friendly and manages the intricacies of emulating the various gaming platforms.

### BRIEF DESCRIPTION OF THE DRAWINGS

Having thus described the invention in general terms, reference will now be made to the accompanying drawings, which are not necessarily drawn to scale, and wherein:

FIG. 1 is a high-level block diagram of an entertainment content distribution system in accordance with an embodiment of the present invention;

FIG. 2 is a flow chart that illustrates the interaction between the client application and host and asset servers to deliver content to a user;

FIG. 3 is a high-level block diagram of the components of a client application in accordance with an embodiment of the present invention;

FIG. 4 is a process flow chart that shows the interaction between the content manager and other client components to track the progress of a download;

FIG. 5 is a process flow diagram of the steps to authenticate the login information of a user;

FIG. 6 is a process flow diagram of the steps to create a new account;

FIG. 7 is a process flow diagram of the steps to verify a user's right to access content;

FIG. 8 is a block diagram that illustrates how a graphical user interface (GUI) manager uses GUI players to deliver content to users of a plurality of different systems;

FIG. 9 is a process flow diagram that illustrates an interaction between a GUI manager and GUI player as the system processes a GUI event;

FIG. 10 is a block diagram that illustrates a hierarchical relationship between a game manager and a plurality of integrated game players and external game players;

FIG. 11 is an exemplary graphical user interface for logging into the system according to one embodiment of the present invention;

FIG. 12 is an exemplary three-dimensional graphical user interface for searching and selecting games according to one embodiment of the present invention;

FIG. 13 is an exemplary two-dimensional graphical user interface displaying information regarding a game according to one embodiment of the present invention;

FIG. 14 is an exemplary two-dimensional graphical user interface displaying information regarding a game according to one embodiment of the present invention;

FIG. 15 is an exemplary two-dimensional graphical user interface displaying information regarding a game according to one embodiment of the present invention;

FIG. 16 is an exemplary two-dimensional graphical user interface displaying information regarding a game according to one embodiment of the present invention;

FIG. 17 is an exemplary two-dimensional graphical user interface displaying information regarding a game according to one embodiment of the present invention;

FIG. 18 is an exemplary two-dimensional graphical user interface displaying information regarding a game according to one embodiment of the present invention;

FIG. 19 is an exemplary two-dimensional graphical user interface displaying entertainment content according to one embodiment of the present invention;

FIG. 20 is an exemplary two-dimensional graphical user interface for managing account settings according to one embodiment of the present invention;

FIG. 21 is an exemplary two-dimensional graphical user interface for managing account settings according to one embodiment of the present invention;

FIG. 22 is an exemplary two-dimensional graphical user interface for managing account settings according to one embodiment of the present invention;

FIG. 23 is an exemplary two-dimensional graphical user interface for managing account settings according to one embodiment of the present invention;

FIG. 24 is an exemplary two-dimensional graphical user interface for managing account settings according to one embodiment of the present invention;

FIG. 25 is an exemplary two-dimensional graphical user interface for managing account settings according to one embodiment of the present invention;

FIG. 26 is an exemplary two-dimensional graphical user interface for mapping controls according to one embodiment of the present invention;

FIG. 27 is a process flow diagram of the steps to determine the catalog data to be presented according to one embodiment of the invention;

FIG. 28 is a process flow diagram of the steps for retrieving a content key according to one embodiment of the invention;

FIG. 29 is a high-level block diagram of an entertainment content distribution system in accordance with an embodiment of the present invention; and

FIG. 30 is a high-level block diagram of the components of a client application in accordance with an embodiment of the present invention.

### SUMMARY

The present invention is directed to systems and methods of delivering entertainment content via a network. An embodiment of the delivery system is configured as a gaming network that distributes on-demand content, such as games, and linear content, such as an audiovisual presentation of a graphical user interface, to end-user computing devices via the Internet or other network. The combination of linear and on-demand content provides users with a managed gaming experience not unlike that of interactive television. The graphical user interface can be manipulated to provide access to the on-demand content. End-user computing devices may include, for instance, a PC running a Microsoft Windows™ or Linux operating systems, Macintosh, cell-phone, portable device, set-top box, or future console.

In one embodiment, a three-dimensional graphical user interface is used to present and allow users to select from available content. With regard to the delivery of a plurality of games, an embodiment of the delivery system provides a client application that allows users to play games from various gaming platforms by managing various game players in a manner that is largely transparent to the user. The various game players include: a) emulators that execute game code written to run on i) arcade game systems, ii) console game systems including hand-held systems, and iii) general purpose computer devices such as Commodore64, Macintosh, and a PC running DOS, b) simulators that simulate how games were run on the original systems, c) native game players that execute game code targeted for the end-user computing device, and d) virtual platform game players that execute game code written for a non-native platform utilizing a general-purpose non-native virtual platform emulator. Examples of such virtual platform emulators include ‘WINE’ to emulate Windows on Linux, and ‘VirtualPC for Mac’ to emulate Windows on Mac OSX.

An embodiment of the present invention herein described is a game delivery system that allows a user to select from and receive delivery via a network of at least one of a plurality of games that can be executed by the game players. The game delivery system includes an asset server that stores software game code and a host server that directs the asset server to deliver a selected one of the games to the user.

Additional embodiments of the game delivery system describe using a client application residing on an end-user computing device associated with the user that displays a listing of available games and accepts a user request to play a game. In some described embodiments, the client application includes a plurality of emulators that are used to emulate the original platforms for which the plurality of games were originally intended to run. The emulators translate or interpret the original platform machine code blocks of the game code to functionally equivalent blocks of compiled instruction set code that run on the end-user computing device. In some embodiments, the client application is configured to begin play of a selected game before the entire game code is downloaded to the end-user device from the asset servers. Game play can be initiated as a foreground process, while additional game assets are simultaneously being downloaded in the background. Additional embodiments describe an incentive system, wherein players are rewarded for completing one or more predefined tasks. Rewards take various forms including badges, unlocked games or levels, and enhanced subscription rights.

Other embodiments of the present invention describe game delivery systems in which a game player can monitor a game as it is being played. Game players are configurable to detect a preset list of keystrokes and to respond accordingly. Thus, for example, a game player may post a score back to the client application upon completion. Other functionality that can be monitored by the game player includes the ability to pause, or exit from a game based upon a predefined keystroke or to obtain a hint for a game.

In various described embodiments, the client application has multiple graphical user interface modules that are configured to interact with different end-user devices. In some cases, the user interface of the system is modified to accommodate the specific type of end-user device, and in other cases the actual game, or at least the list of available games, are modified based on the specifications of the end-user device. Metadata is also described as associated with the game. The metadata may include information about the game, such as, for example, the hardware or software requirements needed to run the game and configuration data needed to instruct the game player how to perform certain operations such as where to save games and how to extract high scores. Other types and uses of metadata are also described.

Also described herein are content delivery systems for providing linear and on-demand content to a user. In various embodiments, these content delivery systems include an asset server that stores at least a portion of the linear and on-demand content and a client application in communication with asset server. The asset server is adapted to deliver the linear and on-demand content to the user via a network, and the client application is adapted to receive and present the linear and on-demand content to the user. The linear content includes an audiovisual presentation of a graphical user interface, and the graphical user interface can be manipulated to provide access to the on-demand content.

In a further embodiment, the linear content further includes the presentation of a host avatar. The host avatar is an animated character that speaks and provides information about content that is available for download. In one embodiment, the host avatar is a human or human-like character that acts like a television show host that welcomes the user to the system and discusses the available content and system options.

In some described delivery systems, the graphic user interface has several layers, and each layer is associated with a subset of on-demand content. As described herein, a host server may manage the delivery of content from an asset server, and the host server initiates delivery of the linear content to the client application when a user first enters the system. The linear content is then delivered to the user until the user exits the system or interacts with the user interface. Again, the system can be configured to work with a plurality of different end-user devices and the client application can be configured to detect one or more hardware capabilities of the end-user system and to conform the presentation of the linear and on-demand content to the system.

Other aspects of the present invention described herein are methods of delivering game content to an end-user computing device associated with a user. The steps described in some of the methods include delivering a graphical user interface that displays a list of available games and allows the user to select a game from the list; receiving input indicative of a first game selection by the user; choosing one game player from a plurality of game players, launching the one game player and initiating game play of the first selected game; monitoring user input during the game play of the first selected game; and returning the user to the graphical user interface upon identifying in the user input one of a predefined set of user inputs.

Additional embodiments include the steps of terminating game play of the first game and allowing the user to start a second game, identifying a second game player associated with the second selected game, launching the second game player and initiating play of the second selected game; monitoring the user input during the play of the second selected game; and taking a game delivery system related action if the user inputs one of the predefined set of user inputs. Still other embodiments add the steps of accessing an account associated with the user in response to the first game selection, verifying that the account gives the user access to the first game selection, and notifying the user if the user lacks access rights to the game or does not have the minimum hardware or software configuration to run the game. Other embodiments enhance this function by offering to upgrade the user account or by offering a trial version or limited time access to the first selected game.

Other aspects of the present invention described herein are systems for delivering game content to an end-user device via a network. Embodiments of these systems include an asset server that stores game data; a datastore that includes game metadata associated with the game data, the metadata including a plurality of index points that logically divide the game data into a plurality of portions, a first index point identifying a portion of the game data that is required to initiate game play of the game, and one or more subsequent index points that identify one or more additional portions of the game data; and a client application that resides on the end-user device and includes a content manager that monitors a progress of a transfer of the game data from the asset server to the end-user device; and a game manager that manages the game play of the game on the end-user device; wherein the game manager receives the metadata from the datastore and periodic updates of the game transfer progress from the content manager and initiates the game play of the game in response to an indication that a portion of the game data identified by the first index point has been transferred successfully to the end-user device.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The present invention is described below with reference to block diagrams and flowchart illustrations of methods, apparatus (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a computing device, such that the instructions which execute on the computing device create means for implementing the functions specified in the system or flowchart blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

A. Content Distribution System Architecture

The present invention is described herein in the context of systems and methods that are configured to distribute entertainment content to clients over a computer network. But one of ordinary skill in the art will readily recognize that the present invention is not limited to the delivery of entertainment content and, in fact, the platform described below can be used to deliver other types of media, software applications and digital content as part of an on-demand service.

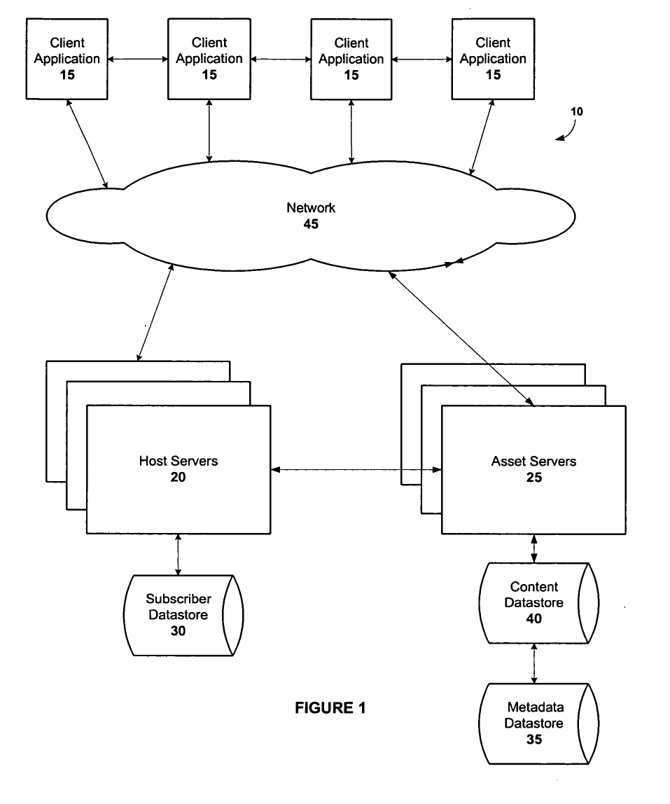

FIG. 1 illustrates a high-level view of an entertainment content distribution system 10 in accordance with an embodiment of the present invention. In this embodiment, several client applications 15 communicate with a host server 20, which can be composed of one or more logical servers deployed on one or more physical servers, and one or more asset servers 25 via a network 45, such as the Internet. In addition, arrows are shown between the client applications 15 to represent the possibility of data transfer between two or more client applications 15 via relay network communication techniques that are well known in the art. In general, each end-user computing device executing the client application 15 has a client manager component that manages relay network communications.

In one embodiment, the various users of the system 10 are distributed over a large geographical area and the network 45 is a wide area network such as the Internet. And the volume of entertainment data passed to the client applications 15 is typically sufficiently large that a broadband link is used to handle the communication that occurs between the client applications 15 and the network 45. But, as described below, the volume and type of data transmitted to and from the client applications 15 can be tailored to the requirements of the end-user computing device used to execute the client application 15. As a result, the bandwidth requirements for the link between the client application 15 and the network 45 can vary, and the processes described herein may be accomplished by any of several known processes for transmitting digital data.

In one embodiment, the host server 20 is realized as a Java application server, one of many known web application server architectures that can be used with the present invention. In an alternative embodiment, for example, a CGI-compliant web server such as an Apache or Microsoft IIS server or the like can be configured as the host server 20. Communication between different host server applications occurs via Java Bean exchange or other known protocols, such as the simple object access protocol (SOAP) or via hypertext transport protocol (HTTP) request/response. A HTTP server and servlet container, such as Jakarta Tomcat 4.1 or Netscape iPlanet 6.1 can provide the services necessary to authenticate users, administer user profiles, and serve content metadata.

As described herein, the host server 20 handles much of the game control and administrative functions required by the entertainment content distribution system 10. But one of ordinary skill in the art will recognize that some or all of the functionality and/or request targets (e.g., content catalogs, leader boards, etc.) described herein may be cached on the asset servers 25 or other machines for broadcast to end-user computing devices. In such case, the host server 20 updates the cached content on a periodic basis and the updated cache is then broadcast to the end-user computing devices.

User access to games and other types of content is typically predicated on having a valid subscription to the service, and the host server 20 may handle the processes of registering new users and modifying the subscription accounts of existing users. A single account may have multiple users and each user on an account may be configured to access a customized set of content. For example, a parent may have children of three different ages and can setup a subscriber account to assign each child a separate user identifier and password. This allows the parent to customize the content for each user to insure that each child can access only that content that the parent believes is appropriate for that child.

In one embodiment, when a user logs into the system 10, the client application 15 captures a user identifier and password and passes the login information to the host server 20. The host server 20 queries a subscriber datastore 30 and determines whether the user login information corresponds to a valid subscriber account. The response to the login authentication process is then passed from the host server 20 to the client application 15 as an XML structure or the like. In some embodiments, a user key entry of login information can be replaced or supplemented with a smartcard or other card reader system that allows a user to use a card on which information is stored that identifies the user as authorized to access the system 10.

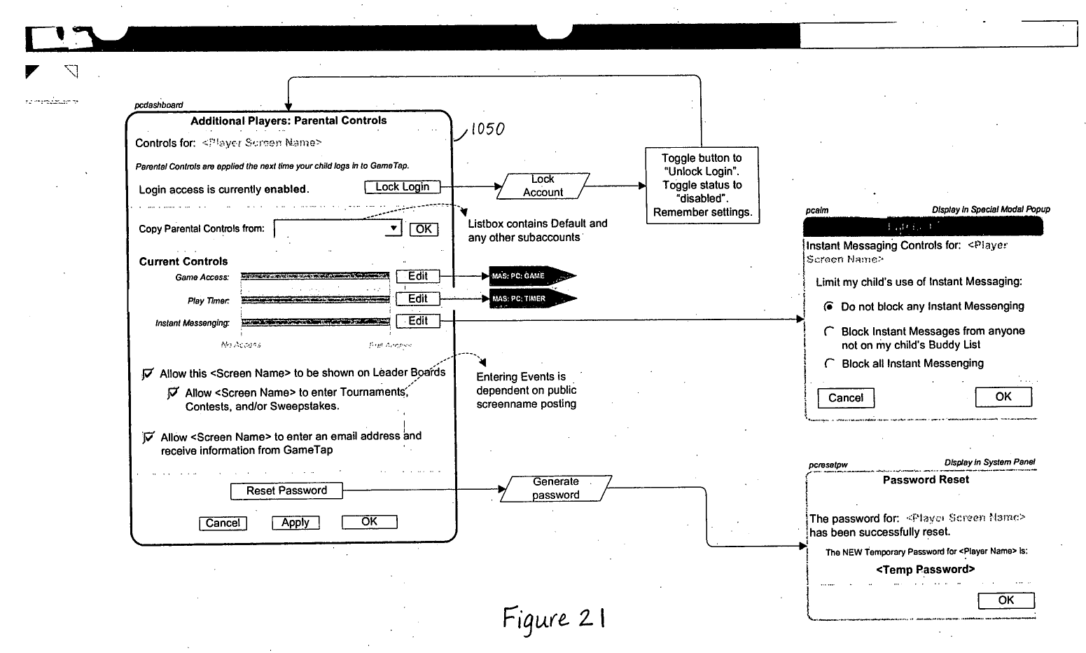

If an account owner limits the content that can be accessed by a user, then the host server 20 may send the client application 15 only those content options that are authorized. Alternatively, the asset server 25 can send the client application 15 a list of every available content option that can be combined with instructions or rules from the host server 20 to “gray out” or hide altogether content that the user is not authorized to access. Still another option is to send the client application 15 a list that includes all available content options, but to deny access if the user requests unauthorized content. User-specific controls (also referred to as parental controls) provided by the system 10 are discussed in more detail below in reference to FIGS. 21-24. Again, one of ordinary skill in the art will recognize that the available content may not be determined dynamically (on a transactional basis) at the host server 20, and instead may be pre-generated and cached on the asset servers 25 (or other suitable storage device) for broadcast to interested end-user computing devices.

When a user selects a game (or other content) the client application 15 sends the host server 20 a request for content. In one embodiment, the content served to the client applications 15 is stored and processed from a plurality of asset servers 25 that are distributed at different places within the network. Substantial benefits in network performance can be obtained by storing and processing content from asset servers 25 that are efficiently distributed across the network 45. But one of ordinary skill in the art will readily recognize that an embodiment of the system 10 can be built with content that is stored and processed from a single, central data location such as the host server 20. The benefits and use of distributed web architectures are well known in the art, and globally-distributed data storage and server systems are available from companies such as Akamai Technologies, Inc.

In one embodiment, when a user initiates a request for a game or other content, the content is distributed from the asset servers 25 to the client application 15. In one embodiment, the communication between the asset servers 25 and client application 15 occurs via a HTTP request/response transaction. In alternative embodiments, communication may occur via a transmission control protocol/internet protocol (TCP/EP) socket connection or via some combination of HTTP and a socket connection. Socket connections are well known in the art as a means of continuous data transmission between computer systems.

In one embodiment, the communication between the host server 20 and the client applications 15 and between the host server 20 and asset servers 25 is via HTTP. Whereas a socket connection requires a continuous connection between two computers, HTTP is a stateless request/response system that maintains a connection between client and server only for the length of the immediate request. After a generic TCP client establishes a HTTP connection with a server and sends a request command, the server returns a response and closes the connection.

In response to a request from a client application 15 for a game or other content, the host server 20 retrieves information about the requested game from a metadata table or datastore 35. The metadata datastore 35 typically stores information about the available content rather than storing the content itself. In the context of game content, the data stored in the metadata datastore 35 may include a game title, release date, genre, number of players, supported game controllers, minimum and recommended system requirements, original platform, and an entertainment software rating board (ESRB) rating or other parental guidance indicia. In one embodiment, the metadata datastore 35 has information about every game that is available to subscribers of the content distribution system 10.

A role of the host server 20 in delivering content to the subscriber is to communicate with the asset servers 25 to direct the delivery of the content to the appropriate client application 15. The host server 20 may also optionally perform several other administrative processes related to the delivery of the content. An administrative process that has already been discussed is verification that the user is authorized to access the requested content. This can occur at the user level to verify that the account owner has not restricted the user's access to the requested content, or the verification can occur at an account level to confirm that the account rights extend to the requested game.

In addition, in one embodiment, the host server 20 is configured to ensure that the client application checks the end-user computing device to confirm that it satisfies the minimum system requirements of the requested game. The client application 15 may be configured to use one of several known techniques to detect the specifications of the computing device on which it is running. The client application 15 then compares the end-user computing device specifications against the minimum and recommended requirements of the requested game defined on the host server 20 and notifies the user whether the game requirements are or are not met.

The secure content in the form of whole files or blocks of data delivered to the client application 15 is stored in a secure content datastore 40 such as an encrypted virtual disk volume 40. Non-secure content such as advertisement video is stored in a non-secure datastore 40, according to one embodiment. Game content, for example, is stored as one or more binary files that resulted from compiling the original game source code. These binary files may or may not be compressed and can typically be packaged as a .zip, ROM, or similar well known file format. If the content is an arcade or video console game, the game package of binary files may contain the machine language used by the original platforms to execute the game along with audio and other media.

When the game content is delivered to a client application 15, a game player in the client application 15 is used to play the game on the end-user computing device. The type of content stored and delivered to a client application 15 via the system 10 is not limited to game content and can include audio, video, and two and three dimensional assets or media, among others, some or all of which can be delivered via streaming (continuous transmission of data) and other known data transmission processes.

FIG. 1 shows an embodiment of the entertainment content distribution system 10 in which the subscriber datastore 30, metadata datastore 35 and content datastore 40 are shown as individual storage systems. But one of ordinary skill will readily recognize that these datastores can be configured as part of a single database or similar data storage device and that a relational database management system (RDMS) such as Oracle 9i can be used to process some or all of the data from a single server.

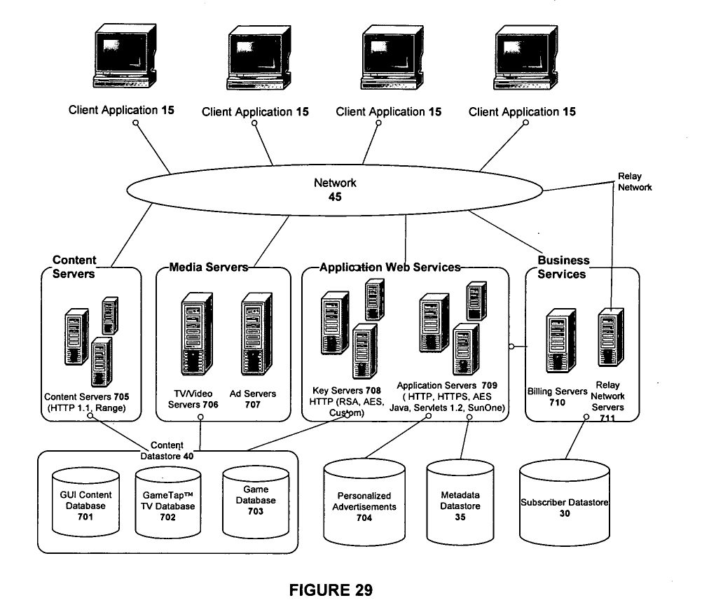

FIG. 29 illustrates another embodiment of the entertainment content distribution system 10 in which various asset 25 and host 20 servers are shown, along with several datastores used by the system 10. The system shown in FIG. 29 may be known as the GameTap™ system as developed by Turner Broadcasting System, Inc. For example, content servers 705, media servers 706, 707, key servers 708, and application servers 709 are types of assets servers 25; and billing servers 710 and relay network servers 711 are examples of host servers 20. In particular, content servers 705 communicate with the content datastore 40, which can include a GUI content database 701, a GameTap TV™ database 702, and a game database 703. The media servers include a TV/video server 706 and an ad server 707 and communicate with the content datastore 40. The key servers 708 and the application servers 709 communicate with the content datastore 40, personalized advertisement database 704, and the metadata datastore 35. And, the billing servers 710 and relay network servers 711 communicate with the application servers 709, the key servers 708, and the subscriber datastore 30. Each of the described servers communicates with the client applications 15 over the network 45.

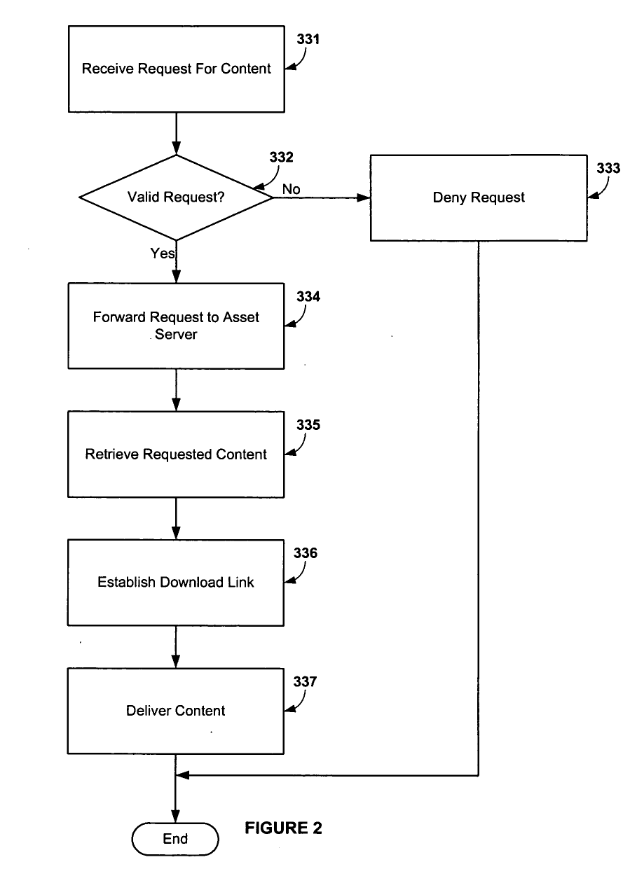

FIG. 2 illustrates the steps required to deliver content to an end-user computing device in accordance with an embodiment of the present invention. In Step 331, the client application 15 sends a request for content to a host server 20. In Step 332, the host server 20 performs some or all of the validation steps described above to confirm that the user is authorized to access the content and, in the case of a game, has a system that can run the game. If a determination is made that the user is not authorized to access the content or that the end-user computing device does not meet the necessary hardware requirements, the process proceeds to Step 333 and the host system 20 returns a response to the client application 15 indicating that the response cannot be processed. If the request for content is validated, the process proceeds to Step 334 and the host system 20 dispatches a command to an asset server 25 to deliver the requested content to the user. In the case of a distributed asset server 25 system, the host server 20 may perform an additional step of determining which of several geographically distributed asset servers 25 is best positioned to deliver the requested content to the user. Alternatively, a determination of which asset server 25 is best positioned to deliver the requested content is performed by a server application that manages the server farms.

In Step 335, the asset server 25 retrieves the requested content from the content datastore 40. In Step 336, the asset server 25 establishes a communication link with the appropriate client application 15 and in Step 337 the asset server 25 delivers the content to the user. Depending on the size of the content file or files being transferred, the content may be delivered in segments or as a single file. For example, games that were originally written for the Atari™ and Sega™ video console systems are typically less than a megabyte in size and require just a few seconds to download to the client application 15. In contrast, a medium-size game written for the Sony Playstation™ console is about 100 megabytes in size, and a game written for a personal computer typically ranges between several hundred megabytes to several gigabytes of data.

In one embodiment, the content delivered by the asset server 25 is stored on one or more physical storage devices of an end-user computing device according to a virtual disk volume scheme implemented by the client application 15. The virtual disk volume scheme includes an arbitrary set of encrypted virtual disk volumes that are implemented on the end-user computing device. The encrypted virtual disk volumes may be created on an as-needed basis for local storage or in each instance in which content is downloaded to the end-user computing device. In one embodiment, each encrypted virtual disk volume is configured to store content of a specific type and secure the content from unauthorized access. Examples of the types of content stored and secured by the encrypted virtual disk volumes include games, media content, and metadata.

The client application 15 can access each virtual disk volume simultaneously or individually at any time during a client application session. A direct application program interface (API) or the end-user computing device virtual disk driver can be used by the client application 15 to access each virtual disk volume. Accessing content can include reading, writing, updating, and deleting content, for example. In addition, each virtual disk volume can be accessed by a name associated with the virtual disk volume, and these names can have various lengths and use various characters. These names may be referred to as logical unit names. Furthermore, each virtual disk volume is associated with metadata, such that the metadata for each virtual disk volume includes the status and attributes of the virtual disk.

A virtual disk manager, such as a single user-device resident device driver, can be used to access more than one virtual disk volume at a time and to control the interaction between the client application 15 and the virtual disk volumes on the end-user computing device. In one embodiment, different instances of content are stored on different virtual disk volumes, and each of the virtual disk volumes can be encrypted using a different security protocol, such as different encryption methods, depending on the security needed to protect the content within each volume. For example, a first virtual disk volume may be used to store bonus material for the game, and a second virtual disk volume may be used to store the actual game. Because the security needed to protect the bonus material is not as great as the security needed to protect the game code, the first virtual disk volume may be encrypted using 128-bit encryption and the second virtual disk volume may be encrypted using 320-bit encryption. Other security methods include alternative key generation methods, methods of retrieving and storing keys, or methods for varying key sizes and protocols.

The virtual disk volume scheme further provides for data stored within a virtual disk volume to be re-encrypted within the client application without the need to re-encrypt and download data from the server. The client application 15 is also configured to dynamically load and unload a memory-resident virtual disk driver each time the client application 15 is started and shut down. This ability avoids the need to restart the end-user computing device if an alternate version of the driver is required. It also avoids system resource usage of the end-user computing device when the client application 15 is not running.

As mentioned above, the system 10 is able to download content from various servers and store the content in the virtual disk volume. For example, the virtual disk volume stores content downloaded from the asset server 25. However, to avoid unauthorized access to the content, the content or a portion of it is encrypted. To access the content, the system 10 requests and receives from the host server 20 a content key associated with the selected content. The content key is then used to decrypt and access the content stored in the virtual disk volume. In particular, the system 10 may first send an encrypted request to the host server 20 requesting the content key for the selected content. The system 10 may then send an unencrypted request to the host server 20 for the content to be downloaded from the asset server 25 to the virtual disk volume on the end-user computing device. Once the content is downloaded, the system 10 can use the content key received from the host server 20 to access the content. A user may then access the decrypted content with the client application 15.

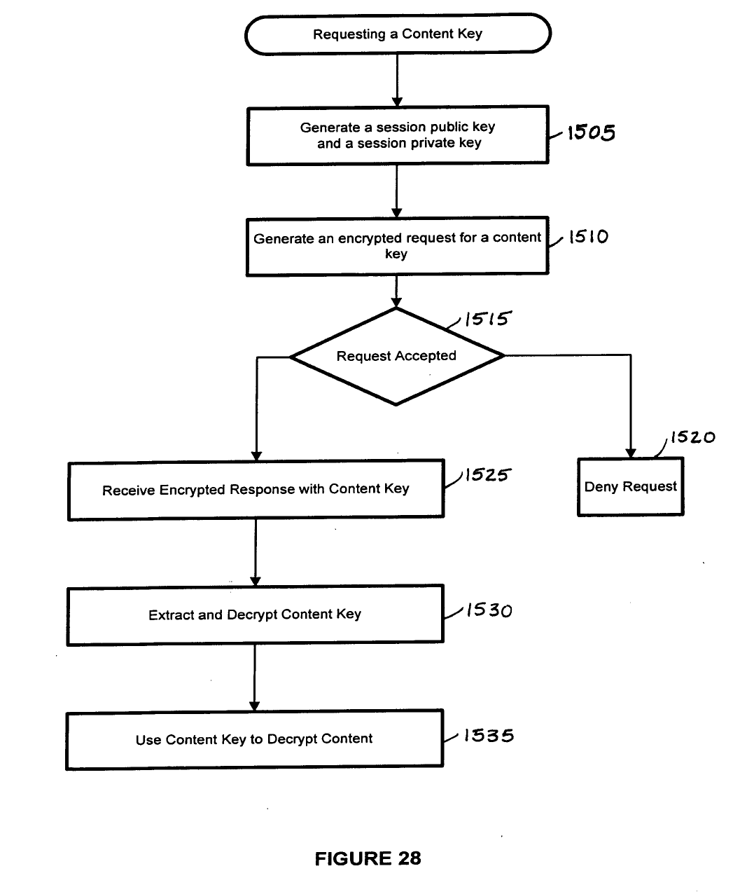

FIG. 28 illustrates an embodiment of the steps taken by the client application 15 to request the content key from the host server 20 and use the content key to access the encrypted content stored in the virtual disk volume. Beginning at step 1505, for the particular client session, the client application 15 generates a session specific public and private asymmetric key pair. The session private key can be used to decrypt the content encrypted by the session public key. Next, at step 1510, the client application generates an encrypted request that includes the identification of the content to be decrypted, a random number, and the public session key. This request is encrypted using a server public key. The server public key is known to the host server 20 and the client application 15 and is generated by the host server 20 as part of an asymmetric key pair that further includes a private server key known only to server. In step 1515, the encrypted request is sent to the host server 20, where it is decrypted using the server private key and accepted or rejected. If the request is rejected, the client application 15 is notified at step 1520 and the process ends. If the request is accepted, the client application 15 receives an encrypted response from the server that includes another random number and the content key, as shown in step 1525. The response is encrypted using the session public key provided in the request. Then, at step 1530, the client application 15 extracts the content key from the response and decrypts it using the server public key and the session private key. Finally, at step 1535, the client application 15 uses the content key to decrypt the content stored on the virtual disk volume. As mentioned above, the process of receiving the content key is separate from the process of receiving the content, and the process for receiving the content includes sending an unencrypted request for the content to the host server 20.

In one embodiment, the content distribution system 10 presents users with an environment that is similar to the television viewing experience from which the users select and access content. In the context of a gaming network, the system 10 manages the user experience by offering commercial advertisements or other forms of audiovisual content between game levels and during download wait times. If the requested content loads completely before the end of the commercial, users can choose to watch the rest of the commercial (or other transitional content) or to proceed to the game.

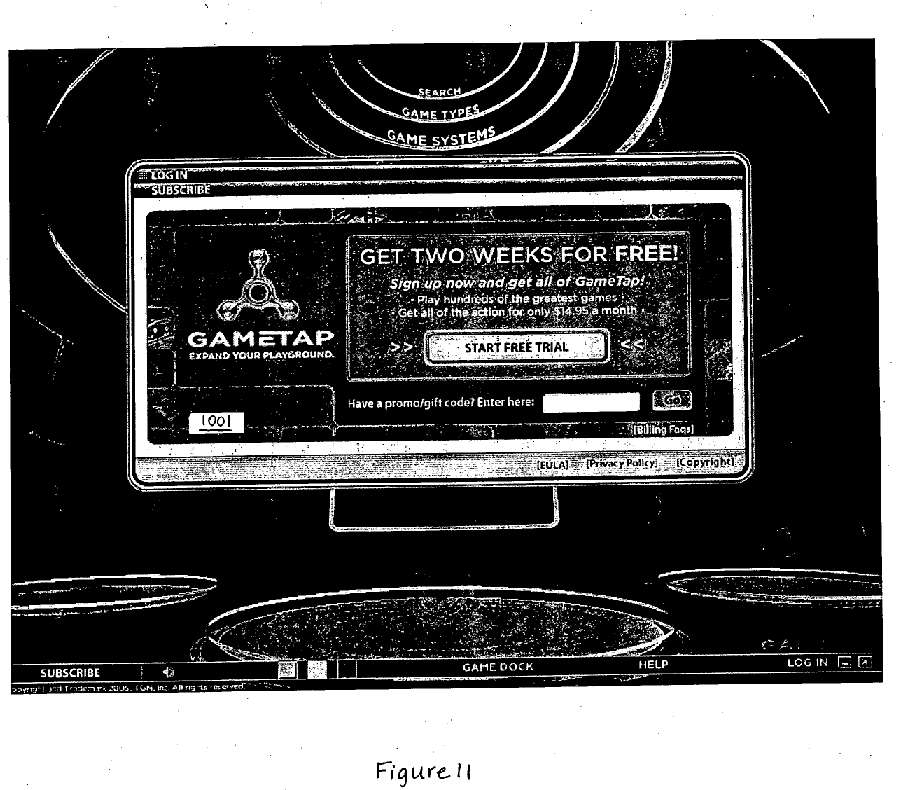

Another aspect of the distribution system 10 that manages the game experience and gives users a television-like experience is the use of a graphical user interface (GUI) environment (sometimes referred to herein as a virtual environment). In one embodiment, the GUI environment includes a series of two-dimensional and three-dimensional media elements, such as windows, or screen views, and dialog boxes. In another embodiment, the GUI environment includes a host avatar placed in a computer-generated setting. The GUI environment serves as the default content and is the first thing the user sees upon entering the system 10, according to one embodiment. Users manipulate objects in the environment or navigate through one or more background or interface settings to select content, browse available content, and set game and system options. In addition, games are entered from the user interface environment and users return to the environment when a game is paused or ended. A more detailed description of two and three-dimensional GUI environments is provided below in reference to FIGS. 11-26.

In an embodiment in which a host avatar is part of the GUI environment, the host avatar serves almost as a television show host or news anchor that greets users with information about new games, contests and other gaming-related information. Users may optionally have the ability to select between several pre-existing avatar images or the system 10 may use one of several known graphics tools to allow users to customize their own avatar. Similarly, the virtual setting for the host avatar may be determined by the system 10 or optionally can be user-customized.

As mentioned above, the host avatar and other parts of the GUI environment may comprise two-dimensional or three-dimensional media elements. According to one embodiment, the system 10 offers both a two-dimensional and a three-dimensional version, and users can choose which version they prefer. The complexity or graphic-intensive nature used for the user interface environment also depends on the end-user computing device used to run the client application 15. For example, a first user runs the client application 15 on a high-end computer system equipped with a fast video card that allows the user to receive and process three dimensional images. This user may opt for a graphic-intensive presentation of the avatar and background environment. A second user runs the client application 15-on a low-end computer system that does not have a fast video card. This user may opt for a two-dimensional version of the virtual environment, or the client application 15 may detect the hardware limitations of the end-user computing device and adjust the content accordingly. Additional types of end-user computing devices used to run the client application 15 include a set top box of a cable or satellite system, a personal digital assistant (PDA) device, cell phone, or other digital electronic device. In one embodiment, the virtual environment is adjusted to adapt to whatever hardware the user uses to access the system 10.

Another aspect of the system 10 is the implementation of a programming reward system that encourages users to participate in a variety of activities or challenges. The challenges can include the playing and mastering of selected games, participation on tournaments and achievement of certain levels in selected games, among others. The incentives can take many forms including the earning of badges or other honoraries, or the unlocking of special games or game levels, to name a few. Badges, levels, tournament trophies and other incentives persist with a user account and graphical summaries of a user's achievements can be shared with other users via an online communication interface such as the AOL instant messenger service.

Still another aspect of the system 10 is the delivery of commercials or other transitional content between game levels or during download wait times. In one embodiment, the transitional content can be targeted to specific types of users based on information in the subscriber datastore 30 or content that is selected by the user. For example, a car manufacturer might request that an advertisement for a sports car be delivered to male users between the ages of sixteen and thirty-five. In an embodiment of the present invention, the content distribution system 10 uses a priority list of paid-for commercial content to determine which commercial to show to users. The commercial at the top of the priority list is used the next time a commercial is delivered to a user and once the commercial is delivered, it moves to the bottom of the priority list. When a commercial that is targeted for a specific subset of users reaches the top of the priority list, the host server 20 performs a check of the account profile for the user to see if the user falls within the advertiser's target market. If the user meets the advertiser criteria, the commercial is delivered to the user. But if a user does not meet the criteria, the host server 20 uses the next commercial in the priority list and the commercial that was skipped remains at the top of the priority list until it is delivered.

Transitional content can also be tied to specific entertainment content. A commercial for sporting equipment, for example, may be associated with a particular game or game genre. If a user requests a game or game category that has been targeted by an advertiser, the metadata associated with the game specifies which commercial or set of commercials should be shown as the game is downloaded and between game levels. As part of the delivery process, the host server 20 checks the metadata to determine if specified commercials or other transitional content have been specified for the requested game. The host server 20 delivers any specific content specified in the metadata datastore 35, and if none is specified, delivers the advertising content in accordance with the priority list. One of ordinary skill in the art will readily recognize that any content can be delivered and that the present invention is not intended to be limited to transitional content in the form of commercial and advertisements. Examples of non-commercial forms of transitional content that can be delivered to a user as a requested game is downloading can include mini-games, tips, game cheats, game instructions and a brief history about the game being downloaded.

As described above, the game content that is delivered to users can involve large amounts of data. If a user requests content that requires that the system 10 deliver a large amount of content to the client application 15, then the user may experience large download delays that detract from the entertainment experience that the system 10 is intended to create. To help alleviate this delay, an embodiment of the distribution system 10 includes a content download process that allows a user to start playing a game before the entire game is downloaded. The mechanics of this process are described in more detail below. In general, the system 10 downloads enough of the game so that the user can begin play and the system 10 downloads the balance of the game as a background process while the user is playing the game in the foreground.

Another pre-load operation that is optionally part of the content distribution system 10 is the download of content while a user is logged off of the system 10. The technology required to perform this process is known in the art and is found in products such as ESPN Motion™. In general, if a connection is maintained between the end-user computing device and the network 45 after the user has logged off of the system 10, the client application 15 uses this connection to download and store content on the hard drive of the end-user computing device. The next time the user logs into the system 10, the client application 15 delivers the locally-stored content, making it appear to the user as if the content was downloaded instantaneously. In this way, the user experience is enhanced and the gaming environment bears a greater resemblance to a television experience than does any known console or personal computer gaming system.

The system 10 is configured to deliver content, such as games, metadata, media and application data such as game players. Content is stored physically in downloadable content units. Content units can be simple content units, such as a data file or a data block, or a structured content unit, such as an organized set of files or data blocks. A set of files or blocks, such as a volume pre-cache or a game level comprising a structured content unit, can be grouped as various data structures, such as a list, tree, or other data structure known in field. The data structures reflect the relationship of simple content units within a structured content unit. The system 10 is configured to automatically identify and update content units that are out-of-date. To identify the content units that need to be updated, an updating module compares the content units stored on the end-user computing device to a representation of the content units stored on a asset server 25 and identifies the content units on the end-user computing device that do not match the representation of the content units on the asset server 25. The updating module then determines how the content units requiring update should be distributed to the end-user computing device.

According to one embodiment, the updating module organizes and optimizes distribution of the updated content units based on the type of content unit to be updated and the location of the content unit on the end-user computing device. Content unit types can include, for example, memory-only, startup, progressive, predictive, and on-demand types.

In one example in which the content unit to be updated is a memory-only type, the updating module identifies the content units that appear to be critical to the content and are purposely not cached on the end-user computing device. As another example, content units critical to the initial rendering or playing of that content are defined as startup content unit types.

Once the out of date content units are characterized and identified, the updated content units are delivered from the host server 20 to the end-user computing device over a network using a stateless protocol, such as HTTP or TCP/IP. If one or more servers are used to deliver the updated content units, the servers can communicate to the end-user computing device in sequence or in parallel to download different segments of the updated content data units at different times. Alternatively, the content units may be delivered from other end-user computing devices in communication with the network 45 using a relay network system, such as P2P. According to one embodiment, the updated content units are delivered to the end-user computing device in incremental units. Incremental units can include data blocks having an optimal size, a group of data blocks, a group of selected files, or a directory tree of files.

In addition to the above considerations, the updating module considers network traffic conditions in determining whether the content units are to be obtained from the server as a content unit or as one or more groups of data blocks of variable sizes. In a further embodiment, the updating module also considers a dynamic client application content state at run-time to determine how to update the content units. And, in another embodiment, the content units are updated linearly from the server during normal content use.

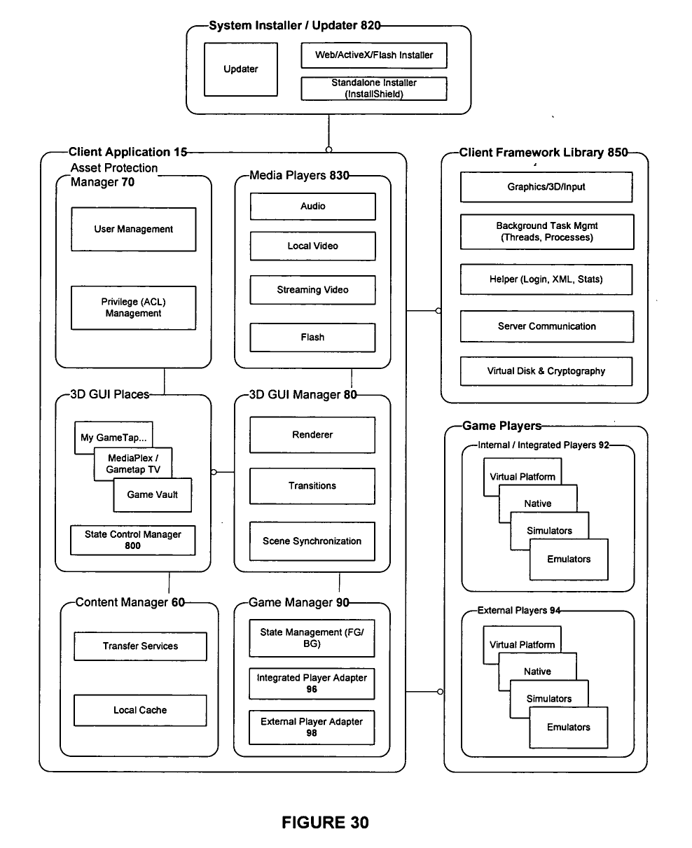

As shown in FIG. 30, an installation/update module 820 installs or updates portions of the client application on an end-user computing device upon request. The installation or updating may be performed by a web installer, an Active X installer, a Flash installer, or a standalone installer, such as InstallShield.

B. Client Application

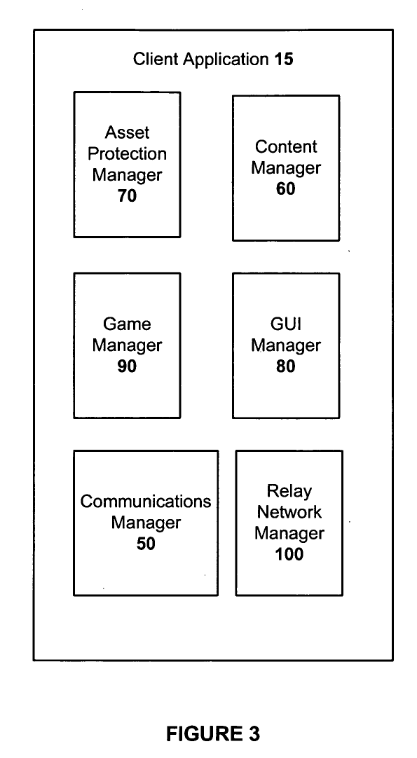

FIG. 3 illustrates a high-level view of the components of the client application 15 in accordance with an embodiment of the present invention. This illustration includes a communications manager 50, content manager 60, asset protection manager 70, graphical user interface (GUI) manager 80, and game manager 90. The client application 15, which is commonly written using C and/or C++ programming languages, integrates the various client components, loading the components as needed depending on user actions. One of ordinary skill in the art will readily recognize that the foregoing is an exemplary configuration and that a client application 15 can be developed using other software languages and architectures.

The communications manager 50 is responsible for communication between the client components and the server-side applications. The communications manager 50 uses known processes to implement the protocols for data transfers including HTTP, TCP/IP and socket communications. In one embodiment, XML or like structures are used to transfer content objects, chat objects, and system communication commands. But one of ordinary skill will readily recognize that other known structures for data transfer can be used with the present invention.

In addition, the client application 15 includes a relay network manager 100 that supports relay network or peer-to-peer file sharing so that content can be shared between various users of the system 10. Peer-to-peer networks that allow all machines in a network to act as a server for the purpose of file sharing are well known in the art. One of ordinary skill will readily recognize that the data transfer efficiencies can be gained by using a relay network and that known techniques for achieving these efficiencies can be adapted for use with the present invention. For example, P2P protocol may be used for communicating data transfers among machines in the relay network.

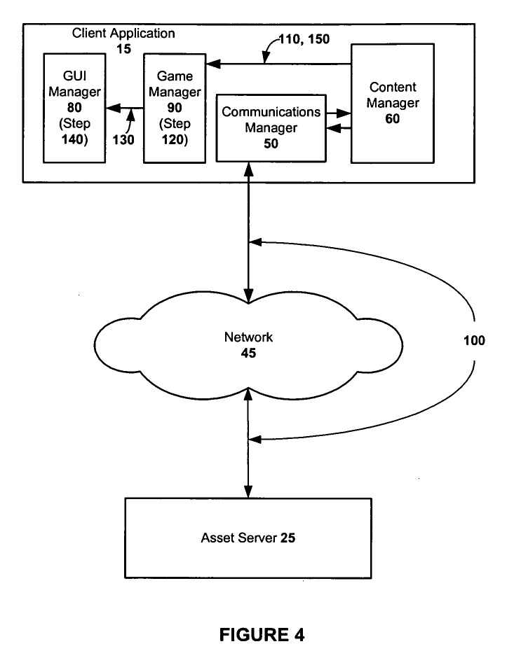

As shown in FIG. 30, the content manager 60 is responsible for the transfer of data between the client and server-side applications and managing the disk space cache of the end-user computing device. The content manager 60 uses known data transfer techniques to support data downloads in foreground and background modes. In either mode, the content manager 60 monitors and reports the progress of the download to the other client components. FIG. 4 is a process flow chart that shows the interaction between the content manager 60 and other client components to track the progress of a game that is downloading in a foreground mode. In Step 100, an asset server 25 establishes a TCP/IP communication (either via HTTP or open socket) with the client application 15 via the communications manager 50 and starts a download. The content manager 60 monitors the download, and, at Step 110, transmits the download progress to the other client components at predetermined intervals. The progress update typically takes the form of bytes downloaded, but the content manager 60 can be programmed to convert the progress to a percentage of the total download. In Step 120, the game manager 90 receives the download progress update from the content manager 60 and, in the illustrated embodiment, the game manager 90 converts the download progress into a percentage of the total download. In Step 130, the game manager 90 passes a percentage download complete update to the GUI manager 80, and in Step 140 the GUI manager 80 displays the download progress to the user. When the download completes, the process moves to Step 150 and the content manager 60 verifies that the download is complete and dispatches a download complete message to the game manager 90.

The content manager 60 also provides progress updates for downloads that occur as a background process. When downloading in a background mode, progress reports are not displayed to the user and instead are published to the interested client components. The following example describes the use of progress reports for a download that occurs in a background mode. Assume that a user wants to play a golf game and in response to the request the host server 20 retrieves the metadata for the requested game. Among other information in the metadata is an indication that the golf game spans several hundred megabytes of data. Recognizing that it will take a substantial amount of time to download that much data, an administrator has previously analyzed the software code for the game and established several benchmarks (sometimes referred to herein as index points). According to one embodiment, the metadata includes these index points and, as a result, identifies that game content that must be downloaded to start the game and the content that must be downloaded for each successive index. One embodiment of the present invention, thus, provides for the progressive download of content, including game content that was originally written to play on arcade-style machines, dedicated game consoles, and personal computers.

The host server 20 communicates the index points to the content manager 60 and game manager 90 (via a header file that precedes the content data) and the download of the game begins. To show the switch from a foreground to a background download, we assume that the content manager 60 downloads the initial portion of the game as a foreground process. But a commercial or other type of transitional content could, of course, be delivered during the initial download, in which case the entire game download would occur as a background process. As the first part of the game downloads, the content manager 60 monitors and reports the download progress to the GUI manager 80 and the progress is displayed to the user. When that portion of the game required to start play has finished downloading, the game manager 90 launches a game player and play begins.

While the user plays the first part of the game, the rest of the game continues to download as a background process, and the content manager 60 monitors and reports on the progress of the download. Periodic download status updates are published from the content manager 60 to the other client components. In one embodiment, the game manager 90 compares the amount of data downloaded against the benchmarks set out in the metadata to determine when benchmark in the game is reached. In the context of a golf game, each benchmark might represent a golf hole and as each benchmark is reached, the game manager 90 recognizes that a new golf hole is available to play. In an alternative embodiment, the content manager 60 performs the comparison of the download progress to the index points, and dispatches a message to the game manager 90 when a new index is reached. In still another alternative embodiment, a new component is part of the client application 15 and has the responsibility of monitoring the download progress received from the content manager 60 and reporting to the game manager 90 as index points are reached.

Updates to the user interface can also be downloaded in a background mode while a user accesses other entertainment content in the foreground. This is another technique employed by the system 10 to enhance the gaming experience. When a user returns to the interface after pausing or ending a game, the user receives an updated version of the interface (a different virtual setting for example) and it appears to the user as though the update downloaded instantaneously.

In one embodiment, before initiating any download as a background process, the content manager 60 determines whether the processing that is occurring in the foreground will be substantially impacted if a download is added as a background task. Software applications are known in the art that measure the processing load on a user system. The content distribution system 10 can leverage these known applications to determine whether adding a background download will impact the processing that is occurring in the foreground. Alternatively, the system 10 restricts and/or eliminates the use of background-mode downloads if an end-user computing device does not meet certain predefined system specifications.

Returning to FIG. 3, the next component of the content distribution system 10 is the asset protection manager 70. In one embodiment, licensing and asset protection functions are combined into a single asset protection module, but one of ordinary skill will readily recognize that some or all of the functions can be separated into multiple components. Licensing functionality that resides in the asset protection manager 70 includes user authentication and registration and request verification. User authentication concerns whether a user has rights to access the system 10, user registration is used to add a new account or a new user to an existing account, and the verification function involves checking a user account to determine whether a user has rights or privileges to perform a requested activity. Some or all of the business logic for these licensing functions may reside in the asset protection manager 70 or the manager may serve as an interface to a third-party service that handles the account administration function.

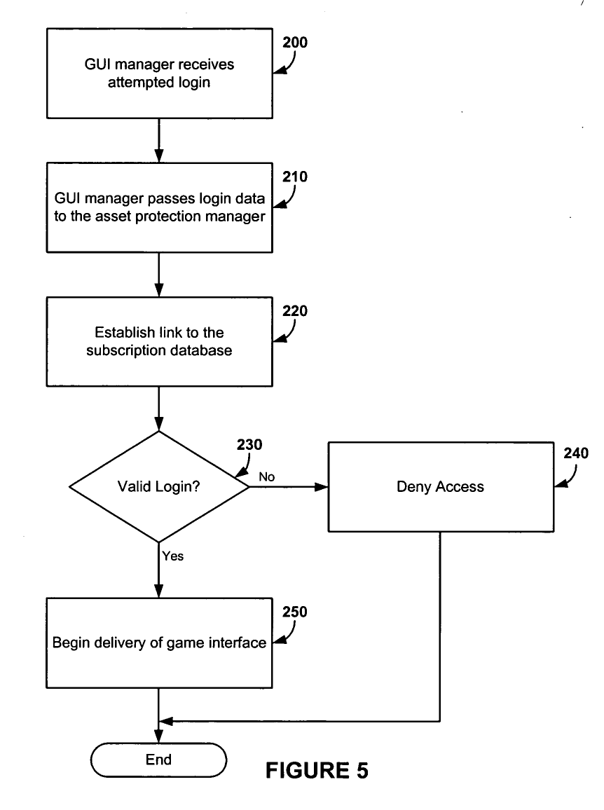

FIG. 5 is a process flow diagram that illustrates the steps required to authenticate the login information of a user in accordance with an embodiment of the present invention. In Step 200, the GUI manager 80 receives a user identifier and password from an attempted user login. The GUI manager 80 is programmed to recognize the keystrokes as an attempted login. In Step 210, the GUI manager 80 passes the login information to the asset protection manager 70. In Step 220, the asset protection manager 70 uses the communications manager 50 to access a subscription datastore 30. In Step 230, the asset protection manager 70 queries the subscription datastore 30 and authenticates the user login. If the login information does not correspond to an active account, the process proceeds to Step 240 and the asset protection manager 70 dispatches a message to the user (via the GUI manager 80) indicating that the user has entered invalid login information. If the login is valid, the process proceeds to Step 250 and the asset protection manager 70 notifies the other client components of a successful login. In one embodiment, upon receiving a successful login, the client application 15 uses processes described below to begin delivering the system's gaming interface to the user.

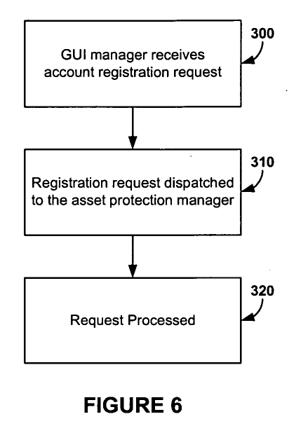

FIG. 6 is a process flow diagram that illustrates the steps required to create a new account in accordance with an embodiment of the present invention. In Step 300, the GUI manager 80 receives a request to create a new account and captures the requisite account information. In one embodiment, the option to create a new account is part of a login presentation and the GUI manager 80 is configured to respond to a create account request with a form that prompts the user to enter the requisite information. In Step 310, the GUI manager 80 dispatches a create account event to the asset protection manager 70 and the in Step 320 the asset protection manager 70 processes the request.

The processing required to create a new account depends on the business requirements of the distribution system 10. As an example, if no fee is associated with the registration process, the asset protection manager 70 creates a new account by verifying that the entered information satisfies the registration criteria and adding a new record to a subscription datastore 30. If the user is requesting a free-trial of an account, the asset protection manager 70 may perform the additional step of determining whether the user qualifies for a free-trial. On the other hand, if the registration requires a fee, the asset protection manager 70 contacts a host server 20 and/or a third-party service to validate the credit card or other payment information supplied by the user.

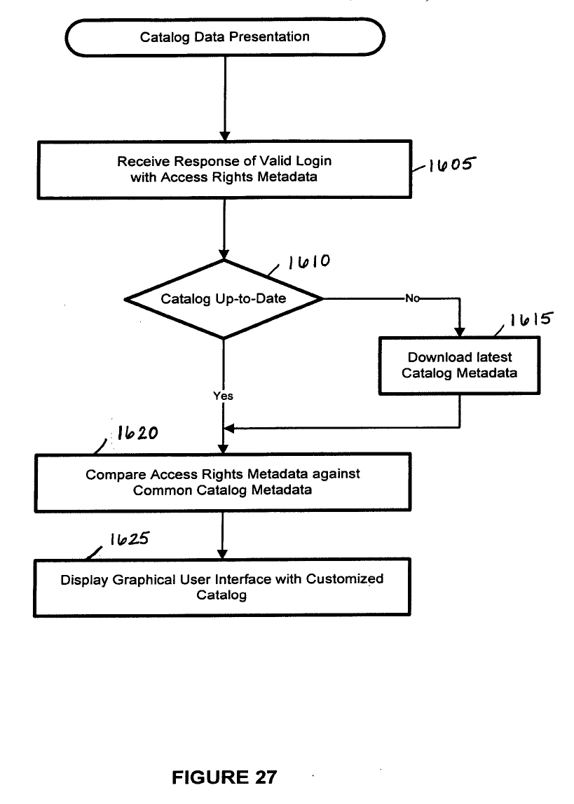

FIG. 27 is a process flow diagram that illustrates the steps required to determine the catalog data that will be presented to the user upon login according to one embodiment. In step 1605, the asset protection manager 70 sends a response to the GUI manager 80 verifying the user's login is valid and including access rights metadata associated with the user. Access right metadata identifies the options that should be presented to the user on the GUI based on the account level of the user and any access controls associated with the user. At step 1610, the GUI manager 80 checks a common catalog metadata to determine if the latest version is downloaded. If the latest version is not downloaded, the latest version is downloaded at step 1615. Then, at step 1620, the GUI manager 80 compares the access rights metadata to a common catalog metadata. The GUI manager 80 then displays a customized catalog that is based on the access rights metadata at step 1625.

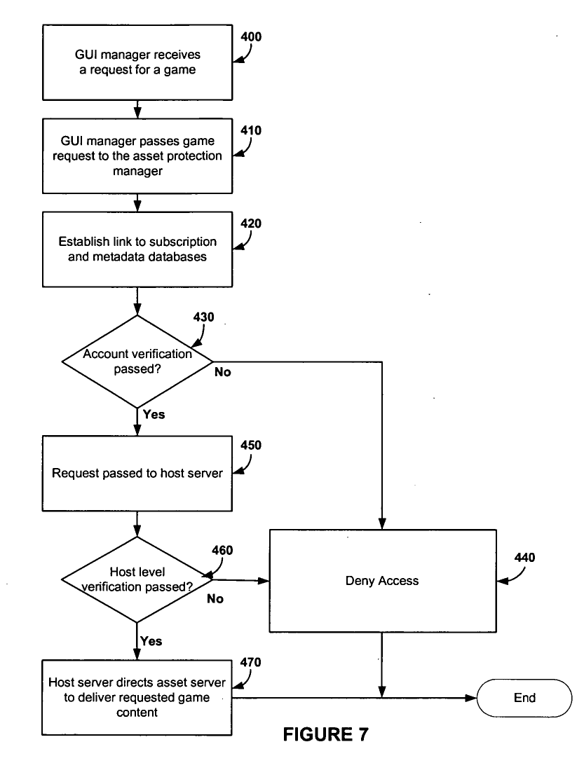

FIG. 7 is a process flow diagram that illustrates the steps required to verify a user's right to access content in accordance with an embodiment of the present invention. As will be readily apparent to one of ordinary skill, many of the processes described herein include, either expressly or implicitly, the step of using the asset protection manager 70 to verify the user right to perform a requested action. In Step 400, the GUI manager 80 receives a user's request to play a game. In Step 410, the GUI manager 80 dispatches the request to the asset protection manager 70. In Step 420, the asset protection manager 70 uses the communication manager 50 to access the subscription 30 and metadata 35 datastores. In Step 430, the asset protection manager 70 verifies whether the account rights extend to the requested game.

Several verification processes can occur before a user is granted rights to access content, but, in this example, the verification is limited to determining whether the account rights extend to the requested content. In one embodiment, a metadata record associated with the requested content has one or more identifiers that indicate whether the game is considered premium content and the types of subscriber accounts that have access rights to the game. The asset protection manager 70 uses this metadata and the account information from the subscriber datastore 30 to verify that the requested access is permitted.

If the account rights do not extend to the requested game, the process proceeds to Step 440 and the asset protection manager 70 dispatches a message to the GUI manager 80 denying the user request. But if the asset protection manager 70 determines that the account rights include the requested game, the process proceeds to Step 450 and the user request is passed to the host server 20. At Step 460, the host server 20 performs additional verification processes. These processes may include a determination whether the account owner has restricted the particular user from accessing the requested content using parental controls functionality, and whether the end-user computing device satisfies the minimum hardware requirements to play the requested game. One of ordinary skill will recognize that the processing illustrated in FIG. 7 is intended to be illustrative and that the asset protection manager 70 or the game manager 90 may perform some or all of these processes.

If the host server 20 does not verify the user request, the process returns to Step 440 where a request denied message is displayed to the user via the GUI manager 80. But if the host server 20 approves the user request, the process proceeds to Step 470 and the host server 20 directs an asset server 25 to deliver the content (the process used to deliver game content to a user is described below).

Another role of the asset protection manager 70 is to protect the rights of access to and use of content distributed by the system 10. A variety of processes are known in the art for securing and protecting digital content. One of ordinary skill in the art will readily recognize that some or all of these processes can be used with the content distribution system 10 to secure and protect the content delivered to users.

In the content distribution system 10, assets in the form of digital content are stored in encrypted form on asset servers 25 and, when downloaded, on the hard drive and memory cache of end-user computing devices. The encryption scrambles the content to make it unintelligible until it has been decrypted using a decryption key that changes periodically and is issued by the asset protection manager 70 as part of the verification process. In one embodiment, the logic for the decryption process is integrated with the game manager 90 and allows the transfer of decrypted content to the game players on demand.

One exemplary method of securing and protecting game assets includes downloading the digital content to a persistent storage device area of an end-user computing device, such as the hard disk, and after the user is finished playing the game, deleting critical game content units from the persistent storage device. Critical content units can include blocks of data that are necessary for playing the game. By deleting the critical blocks from the persistent storage device after the game play is complete, the user cannot obtain a working copy of the game assets from the end-user computing device. This function can also be used to decrease subsequent download time of the same content. Specifically, if a user subsequently requests to access the same content, the client application only needs to download the missing critical content units because the remaining content units are still stored on the user device.

Another exemplary method of securing and protecting game assets includes downloading only non-critical content units of the content to the persistent storage device of the end-user computing device and downloading the critical content units to a temporary memory location. This method prevents the critical content units from being persistently stored on the user system. This function can also be used to decrease subsequent download time of the same content. Specifically, if a user subsequently requests to access the same content, the client application only needs to download the missing critical content units because the remaining content units are still stored on the user device.

One embodiment of the present invention also includes systems and methods for identifying which blocks are critical content units in each game. For example, in one embodiment, the system searches for and recognizes a particular tag or other identification marker associated with critical content units. In another embodiment, the game software provides to the system a map that identifies the critical content units, and the system opens the map to determine which content units are critical. In yet another embodiment, the system analyzes characteristics of the content units to determine which content units are likely to be critical. For example, the system may look for particular executable commands that relate to important functions of the software, which may indicate a critical content unit. In addition, the system may determine which content units are retrieved and used frequently by the software, which may indicate a critical content unit. Furthermore, the system may identify critical content units while the system is processing the game or at another time, such as when the system is offline.

In one embodiment, the system is configured for removing or corrupting all critical content units after the user is finished playing the game. In an alternative embodiment, the system is configured for removing or corrupting only a portion of the content units in a randomized manner. By randomizing which content units should be removed or corrupted, the system is less susceptible to reverse engineering to determine which blocks are removed or corrupted. For example, after the system has determined which content units are critical, the system uses a random number generator to randomly select the critical content units to be corrupted. In addition, the system can randomly select non-critical content units and critical content units to corrupt using the random sequence.

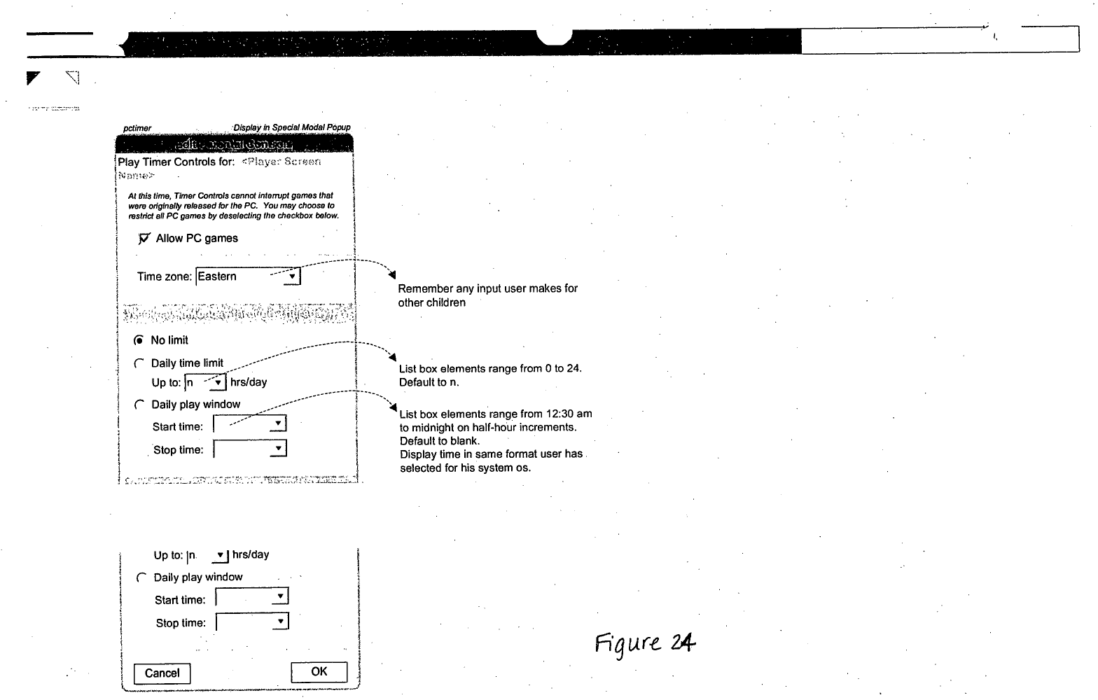

Returning again to FIG. 3, the next component in the client application 15 is the GUI manager 80. In general, the GUI manager 80 accepts input from the users and displays output to the users. User input typically comes from a keyboard and mouse but any gaming or input device that is known in the art can be supported. For example, in the context of a game distribution network, the GUI manager 80 accepts input from devices that include joysticks, game pads and gas pedal/steering wheel combinations, among others. And because the client is not limited to computer systems, user input can be received from electronic devices such as mobile phones, wireless handheld devices and cable set top boxes, to name a few. Furthermore, the client application 15 provides a GUI interface that allows a user to customize the control mapping for a particular game, based on the type of end-user computing device used by the user. For example, if a user is playing a game that has been played traditionally with a joystick and the user is playing the game on a PC, the user can select which keys on the keyboard correspond with the up, down, right, and left motions of a joystick. This functionality is described in more detail in reference to FIG. 24.

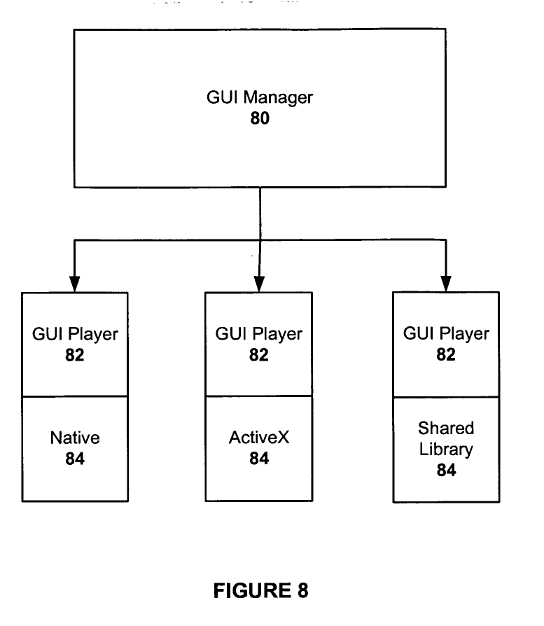

FIG. 8 is a block diagram that illustrates how the GUI manager 80 uses device-specific components (referred to herein as GUI players 82) to receive and display output to different end-user devices. According to one embodiment, GUI players 82 are configured to accept input from and display output to specific types of end-user devices. Each GUI player 82 performs the same function (input and output) and interacts with the GUI manager 80 via a common interface. Each GUI player 82, however, is written to interact with a different communication layer 84 and a different set of end-user devices. As shown below, the GUI manager 80 handles the business logic for GUI events while GUI players 82 handle the presentation of the output to the end-user device. The separation of the GUI component responsible for the presentation (GUI players 82) from the GUI component that handles the GUI business logic (GUI manager 80) offers a degree of scalability that is not present in current systems. In one embodiment, the GUI manager 80 need not be modified to add support for a new end-user device, and support for a new device can be added by writing a new GUI player 82 to interface with the communication layer 84 of the end-user device.

Three known communication layers 84 are shown in the FIG. 8, the Native Windows environment, ActiveX controls and Dynamic Link Libraries (DLL) or another shared library. One of ordinary skill will recognize that the present invention is not tied to these communication layers and, in fact, one or more of these layers may be replaced by alternatives that are known in the art. These are intended to be illustrative and one of ordinary skill in the art will recognize that other communications layers are known in the art and can be used with the present invention. In one embodiment, the communication layers 84 act as interfaces between the GUI players 82 and the hardware components of the different end-user devices. As an example, a module known as CTL3DV2.DLL is part of the DLL communications layer 84. When called, this DLL module performs the graphic function of drawing a three-dimensional border around a dialog box. The benefit of having this module as part of a communications layer 84 is that a GUI player 82 can call this DLL module whenever it needs to draw a three-dimensional border in a DLL-supported device. Without this communications layer 84, to achieve the same result a GUI player 82 must interface directly with the hardware drivers of every end-user device supported by the system 10.

The choice of GUI player 82 determines the type of presentation that the user receives. Thus, a first GUI player 82 that is written to support a high-end computer system may produce a presentation that shows a user interface and host avatar as a full-screen, dynamic, three-dimensional image. A second GUI player 82 that is written for a lower-end computer system may produce a two-dimensional presentation of the interface and avatar. And a third GUI player 82 written for a handheld wireless device or mobile phone may limit the presentation to a text message. GUI players 82 can thus modify the presentation of the system 10 to meet the specific hardware requirements of an end-user device. Used this way, the GUI players 82 allow the content distribution system 10 to support a broad range of end-user devices.

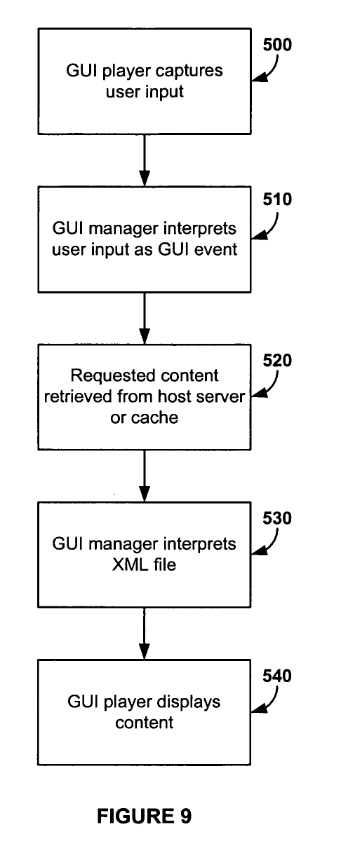

The following paragraphs describe the interaction that occurs between the GUI manager 80 and GUI players 82 as the system 10 processes a GUI event. FIG. 9 illustrates the interaction in the context of a user request for a listing of available content that begins with the letter “A.” In Step 500, the GUI player 82 captures keystrokes (or another form of input) that the user enters to request a list of available content. In one embodiment, the role of the GUI player 82 is to interact with the end-user device to capture the input, but not necessarily to interpret the input. Thus, in Step 510, the GUI player 82 passes the input to the GUI manager 80 and the GUI manager 80 performs the algorithm that interprets the input as a request for a list of available content that begins with the letter “A.” The GUI manager 80 also performs the logic of determining whether the requested content is stored in local memory or whether a call must be made for data that is stored at a remote location.

Step 520 represents the processing that is required to obtain the requested content. The content may be stored locally, or the GUI manager 80 may need to dispatch a content request from the communication and asset protection managers to retrieve the requested information. In Step 530, the GUI manager 80 builds the list that the user requested and sends the list to the GUI player 82. The GUI manager 80 may receive only that content that satisfies the user request, or the GUI manager 80 may receive a complete list of all available content. In the latter case, the GUI manager 80 is programmed with sufficient logic that it filters the content to show only that content that begins with the letter “A.” Then if the user later requests content that begins with another letter, the GUI manager 80 can respond to the request without invoking another call to the host server 20.

In one embodiment, data is transferred from the GUI manager 80 to the GUI player 82 as a XML file, though other methods of data transfer can be used in alternative embodiments. Because the GUI logic is separated from the GUI presentation, the GUI manager 80 provides the raw data to the GUI player 82 but offers no instruction as to how the content should be displayed. In Step 540, the GUI player 82 receives the XML file and leverages the necessary presentation logic and/or presentation template to display the list in a manner that is appropriate for the associated end-user computing device. While the vast majority of business logic associated with GUI operation occurs in the GUI manager 80, the GUI player 82 and/or presentation logic associated with the GUI player 82 can process some basic GUI functions that do not require a call to the GUI manager 80. As an example, the GUI player 82 will allow a user to scroll through the list of content without dispatching another GUI event to the GUI manager 80.

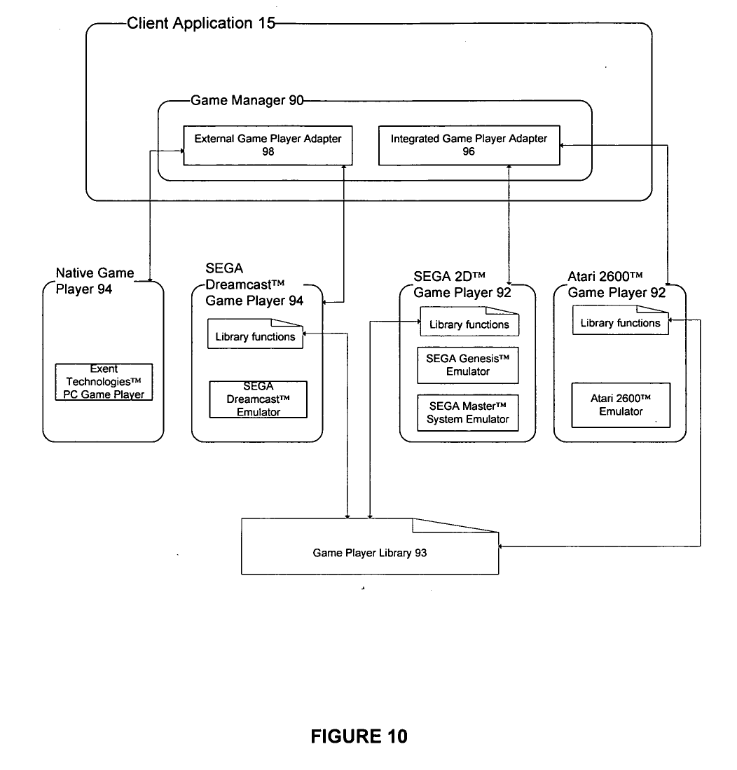

Returning again to FIG. 3, the next component shown in the client application 15 is the game manager 90. In general, the game manager 90 dispatches the user's request to play a game to an appropriate game player 92, 94 and handles the business logic associated with playing a game, including the audio and video associated with game play. FIG. 10 is a block diagram that illustrates a hierarchical relationship that exists between the game manager 90 and a plurality of integrated game players 92 and external game players 94, such as emulators, in accordance with an embodiment of the present invention. Integrated game players 92 typically include game players that share the same operating system process and graphic and memory resources as the client application 15, thus enabling better data exchange between the game player 92 and the client application 15. An example of an integrated game player 92 is a simple 2-D emulator that supports the Atari 2600™ console. In contrast, external game players 94 include game players that are typically spawned by the client application 15 into a separate operating system process, must manage their own graphic and memory resources, and have limited means to easily exchange data with the client application 15. An example of an external game player 94 is a native game player that runs PC games on a PC end-user computing device.

Emulators are a specific type of game player that interpret or translate machine code for the game that is written for different devices such as arcade systems and console gaming systems. Console emulators are complex pieces of software that are written to emulate the hardware and software of a particular video game console, such as those systems made by Sony, Microsoft, Sega, and Atari, among others. For purposes of the present invention, a video game console is a specialized computer system that is configured to play video games. Game software for video game consoles is available on CDs or DVDs, although earlier game machines used cartridges in which the game software was stored on read only memory (ROM) chips. Video game consoles can be powered by microprocessors similar to those used in personal computers, but the hardware in a video game console is controlled by the console manufacturer, and the software is specifically geared to the machine's capabilities. A special subset of video game consoles are handheld video game systems, such as the Sega GameGear™ and Atari Lynx™ machines. These are self-contained, portable and usually battery-operated versions of a video game console.

In addition, emulators known in the art include single game emulators and single-system emulators. Examples of single system emulators include the Atari 2600™ emulator, the Apple II™ emulator, the Intellivision™ emulator, the Sega Genesis/32/Master™ emulator, and the Dreamcast™ emulator. These emulators only emulate one kind of game or system. Multi-emulators are also known and emulate multiple games or types of games. For example, the Multi-Arcade Machine Emulator (MAME) emulates hundreds of arcade games that originally were written for hundreds of different arcade systems, many of which were equipped with different hardware configurations. Because each arcade game was written for a specific hardware configuration, MAME uses a driver system to emulate each game. And, as a result, each arcade game that runs on MAME uses a driver that is specific to that game.

Another well known problem with emulators is that each emulator has its own unique way of loading games. A user that intends to run a game on an emulator must read the documentation that accompanies the emulator to understand how the emulator works and what games it supports. And in many cases, the user will find that the emulator does not perfectly emulate the abilities of the system that it is intended to copy. With some emulators, the imperfections cause minor problems such as a glitch in graphics or a slight timing problem. In other cases, an imperfection has a more drastic impact that results in the game not running or a game that runs without sound, joystick support, or some other significant features.

For a personal computer system that runs a version of Windows™ or a similar operating system, when an emulator, such as MAME, launches a game such as PacMan™ (which literally requires a command like C:\MAME PACMAN), the game is displayed in a full-screen Windows DirectX mode. As the emulator runs the game, there is no communication between the game and the emulator launching system. However, as shown in FIGS. 10 and 30, one embodiment of the system 10 provides integrated 96 and external game player adapters 98 that fulfill this role by supplying the missing interface between the game players 92, 94 and the client application 15. Although the interface methods and calls specified in the integrated 96 and external game player adapters 98 are standardized to a similar format, the implementation of the interface methods and calls is different for integrated game players 92 and external game players 94.

With reference to FIG. 10, game players 92, 94 are specific emulators, simulators, native game players, or related sets of thereof for which a portion of the software components have been reorganized to interface with different aspects of the gaming system 10. For example, a Sega Game Player 92, which is used to emulate games originally written to run on Sega Genesis™, Sega Master™ System and Sega 32™ console gaming systems, includes additional software components that allow the emulator to interface with the gaming system 10 and does not include other software components of the emulator that are not needed to interface with the system 10, such as those components provided by a game player shared library 93.

As shown below, the game manager 90 handles the business rules associated with game delivery, and the integrated game players 92 and external game players 94 handle the actual mechanics of delivering game play functionality to a user. This separation of the client components that handle game delivery (integrated game players 92 and external game players 94) from the client component responsible for the business logic (game manager 90) offers a degree of scalability that is not present in current systems.

Game player adapters handle the processing required to make the appropriate game player 92, 94 launch the game. As shown in FIG. 10, integrated game player adapter 96 handles the processing required by integrated game players 92 to launch a game and external game player 94 handles the processing required by external game players 94 to launch a game. Both integrated and external game player adapters 96, 98 use a common messaging format that allows them to communicate in a generic fashion with the game manager 90.

In one embodiment of the invention, each integrated game player adapter 96 is written as a tight interface for a particular game player 92 and accesses the memory locations that the game player 92 uses to control a game. Thus, for example, the integrated game player adapter 96 knows the specific memory locations that an integrated game player 92 uses to store data for saved games, game options, current scores and high scores. As a result, the integrated game player adapter 96 can track and report on a user's location and status within a game.

In one embodiment of the distribution system 10, some of the functionality of integrated and external game players 92, 94 are normalized and stored in a separate shared library 93. As a result, new game players 92, 94 only need to implement platform-specific game related functions while the graphics, display, and user interface functionality layer can be common for a plurality of game players 92, 94. The game player shared library 93 may, for example, include the methods to play sounds or map game controllers. For example, in the case of the presentation logic, many integrated game players 92 use the exact same presentation logic to compress a game image. Rather than have the same code repeated in each of the plurality of integrated game players 92, the system 10 uses the game player shared library 93 to centralize the code used by the associated integrated game players 92. A benefit of this approach is that the code can be updated with a single change to the game player shared library 93 rather than necessitating code changes in each of the related game players 92, 94.

Another benefit of this architecture is that algorithms or software routings developed in the game player shared library 93 can be made readily accessible to multiple external game players 94, such as the Dreamcast™ Game Player. For example, many external game players 94 use a convolution filter or other interpolation routines to expand a game image so that the image can be rendered on a display device with better resolution than the display of the original system for which the game was written. While this functionality is present in several external game players 94, some convolution filters are better than others at rendering the image. The game player shared library 93 allows a routine to be stored in a single location and made available to multiple external game players 94. If the routine is later improved (or a better routine discovered), an update can be affected across all of the calling external game players 94 by simply changing the code stored in the game player shared library 93.

In an exemplary embodiment, when a game is launched that was originally formatted for a console device, the game player 92, 94 monitors the keystrokes (and other supported input) of a user as the user plays the game. During game play, most user input relates to game play so the game player 92, 94 takes no action and allows the emulator to respond to the user input with an appropriate game play-related action (i.e. a user presses the spacebar to jump and in response the emulator causes the user's in-game character to jump). But if the user input is one of a predetermined list of reserved keystrokes, control is passed to the game player 92, 94 to take an appropriate system-related action.

The following paragraphs illustrate how game players 92, 94 and game player adapters 96,-98 are used as an interface between an emulator that runs a game originally written to run on an arcade gaming system and a game delivery system that controls the emulator.

An embodiment of the distribution system 10 is a game delivery system that establishes a keyboard standard such that as a user plays a game certain reserved keystrokes will cause certain system-related events to occur no matter what game the user may be playing at the time. Thus, for example, the ESC key might be reserved by the game delivery system as a command to pause a game, while the function keys F1 through F6 might be reserved to start, stop, resume, save, load and post a game score, respectively. A role of the game players 92, 94 in such a system is to monitor the input as a user plays the game and to initiate the appropriate system-related action when the game player 92, 94 detects that the user has hit one of the reserved keys.

One of ordinary skill will recognize that some traditional emulators may require modification to adapt to this game delivery system model that uses a game player shared library 93. Thus, for example, if an emulator was originally written to capture and process keystrokes for a game-related activity, this functionality is replaced with standardized function calls to the game player shared library 93.

This interaction between the game manager 90, game players adapters 96, 98, and integrated 92 and external game players 94 allows a user to pause in the middle of a game and enter the GUI environment (i.e. the virtual game environment). From the interface, the user can return to the game, save the progress in the game, launch a new game or access the default content (i.e. a host avatar) associated with the interface. By returning the user to the interface and pausing, rather than terminating the emulation, the distribution system 10 provides a managed gaming experience that does not presently exist. This continuous delivery of entertainment content is a stark contrast to the disruptive experience provided to users in existing gaming networks. In other emulation based game systems such as MAME, when a user exits an emulated game, the user is dropped back into a launcher environment which is not functionally related to an emulator or a game. Should the user wish to play another game, he or she typically must select an appropriate emulator executable and enter the unique set of commands required by that emulator executable to start the new game.

In addition, as mentioned above, in an embodiment of the present invention, the user can save his or her progress in the game before exiting the game. Before exiting the game, the game manager 90 stores a user's progress point in a game and returns the user to the progress point upon the user's request at a later time. Furthermore, the game manager 90 stores individual progress points in a game on a per user basis, which allows each user to save his or her progress in a particular game and return to the progress point for the user at a later time. The system analyzes the code of the game when the user decides to save the game. A pointer is created and stored in memory. When the user wishes to resume the game, the pointer is retrieved and the game is started where the user left off.

The following paragraphs illustrate the interaction between the game manager 90, game player adapters 96, 98, integrated game players 92, external game players 94, and other client components to deliver a game to a user in accordance with an embodiment of the present invention.

When a user requests access to a game, the game manager 90 receives the request from the GUI manager 80. The game manager 90 then verifies through the asset protection manager 70 that the user has the right to play the game. The game manager 90 also contacts the subscription datastore 30 and/or the metadata datastore 35 to confirm that the user system satisfies the hardware requirements of the game and to determine whether the account owner has established any parental control options to preclude the user from accessing the game. The metadata also identifies a game player adapter 96, 98 and a game player 92, 94 that is associated with the requested game. For example, if the user requests a game that was originally written for a Mac and the end-user computing device is a PC, the metadata identifies the external game player adapter 98 as a proper adapter and a specific native game player as the correct external game player 94.

Unless the requested game is stored locally on the user system, the game manager 90 dispatches a request to the content manager 60 to download the game from an asset server 25. If the game uses download benchmarks, the game manager 90 may monitor the download progress, or the game manager 90 may wait for an indication from the content manager 60 the download is complete. During the download the game manager 90 may handle the download and delivery of an advertisement or other transitory content to the user. The transitory content can be specified by the metadata and/or determined by the host server 20. When the game download is complete, or in the case of a benchmarked-game when enough of the game has been downloaded to start play, the game manager 90 launches the game player adapter 96, 98 and game player 92, 94 and play begins.

An aspect of the present invention is the transparent delivery of an emulated game to a user. As illustrated in the foregoing process, the only action required by the user to initiate a game is to identify (via a mouse click or other input) a game title that the user wants to play. The game manager 90 handles the determination of which game player 92, 94 is required to play the selected game and the game player adapter 96, 98 that handles the processing required to make the appropriate game player 92, 94 launch the game. One embodiment of the game delivery system 10 thus delivers games that were originally written for a variety of game platforms, and emulates those games on end-user computing devices using processes that are transparent to the user and are delivered to the user through a common and consistent user interface. And because the presentation of content is handled by a GUI player 82, the games delivery and emulation processes occur independently of the type of end-user computing device used to access the system 10.

The following paragraphs describe how games written for a variety of gaming devices are delivered to users in a content distribution system 10. With reference to FIG. 10, a game manager 90 is shown communicating with two integrated game players 92 through the integrated game player adapter 96 and two external game players 94 through the external game player adapter 98. A game delivery system 10 includes many game player adapter and game player combinations, and those shown in the figure are intended to illustrate the broad range of platforms and games supported by the system. For example, a first integrated game player adapter 96 is shown interfacing with a Sega Game Player, which emulates the functionality of Sega Genesis™, Sega 32™, and Sega Master™ system consoles. The integrated game player adapter 96 also interfaces with the Atari 2600™ emulator. The external game player adapter 98 interfaces with a native game player, such as an Exent Technologies™ player that supports games written for personal computers (hereafter “PC games”) and a Dreamcast™ Game Player which supports the Sega Dreamcast™ console.

Whether an external game player 94 is required to play a PC game may depend on the computer platform that the game was originally intended to support and the type of device that is used to access the game delivery system 10. Thus, if a game was written to support only Macintosh™ computer systems, an emulator may be required to play the game on a computer that uses the Windows™ operating system, and vice versa. But, in many cases PC games are written to support multiple computer platforms, and these games can be delivered to users without using an emulator.

As illustrated in FIG. 10, the game delivery system 10 supports the delivery and play of PC games through a specific native game player. But the PC games that are not tightly controlled by an external game player 94 are handled a little differently than other games. Specifically, when the game delivery system 10 starts to execute a PC game, it relinquishes control over much of the end-user device to the PC game. This is largely unavoidable due to the fact that each PC game uses the user's computer resources in a different way.

Similarly, for example, when a game delivery system 10 runs an emulated game, an integrated game player 92 knows exactly how the emulator will respond to each user action. If a user decides to save a game, the integrated game player 92 knows where in memory the saved game information is stored and has the option to store the data locally or to store it remotely server-side. In contrast, unless the external game player 94 is written to interface to a specific PC game, the external game player 94 that controls the game has minimal information about the resources the game uses. In most cases, the external game player 94 will not know where a PC game stores its saved game data and, as a result, cannot intercept and forward the data to a server-side storage location.

In one embodiment, however, external game players 94 are used to monitor the user input to PC games. While the external game players 94 do not exert the same degree of control that is used for emulated games, external game players 94 do support some system-related functionality. Thus, for example, an external game player 94 retains the ability to start and stop a PC game that is being played in a game delivery system 10. Moreover, when a user leaves a PC game, the external game player 94 in conjunction with the game manager 90 and other system components returns the user to a client application user interface, and thereby provides the user with a non-disruptive, managed entertainment experience.

One embodiment of the content distribution system 10 is thus a game delivery network that delivers games that were originally written for a plurality of different console, arcade, and computer gaming systems. An aspect of the distribution system 10 is a user-friendly game network interface that launches a game player 92, 94 in response to a user selection of a game. A single click of a mouse (or other supported input device) on a title causes the corresponding game to be downloaded and launched to the user. The system 10 handles the selection of an appropriate game player 92, 94 for the game and the delivery of the game is independent of the device the user uses to access the network.

According to the embodiment shown in FIG. 30, the client application 15 further includes media players 830, which may include audio players, local video players, streaming video players, and flash players. In addition, the client application 15 includes a startup/state control manager 800 that manages the startup and shutdown operations of the client application 15 and controls the status of the client application 15 during each client session. The startup/state control manager 800 also works with the GUI manager 80 in managing the various user interface sections that are presented to the user through a visually integrated user interface. The various user interface primary sections include a gateway interface, a vault interface that presents the various types of content selectable by the user, a mediaplex section that presents media content to the user during downloads or between game play, game information interfaces that present information on content that may be selectable by the user, and a television interface section that provides streaming television while games or other content are being downloaded to the system.

The embodiment shown in FIG. 30 also includes client framework library 850 that stores tools and plug-ins that can be used by various components of the client application 15 and the external game players 94. For example, files that may be included in the client framework library include dynamic or static library files that contain graphics processing functionality (such as 3-D renderer), user input plug processing functionality, helper files such as logging tools, XML processing tools, statistical tools, server communication functionality (such as TCP/IP communication), background task management tools (for processing of multiple threads and processes spawned by the client application 15), virtual disk tools and cryptography tools.

Typically, after downloading a gaming system or a particular game, such as a PC game, the user has to reboot his or her computer before the user can initiate play of the game. One embodiment of the present invention, however, advantageously allows the user to download the gaming system and games and initiate play of each game without having to reboot the computer. In this embodiment, after or during the downloading of a game to a memory cache of a user's computing device, the device can retrieve the config.sys file or the .ini file and update these files with information concerning the game. After the files are updated to include information about the game, the device can use these files without having to reboot.

Another aspect of the system 10 is the ability to return the user to the game network interface when the user pauses or terminates a game. In known gaming systems, when a user leaves an emulation program the user is typically dropped to an operating system that controls the user's system. If a user wants to play another game, the user has to re-launch the gaming system and select a new game. In addition, in known gaming systems, if a menu that lists available games is provided, it serves only as a launching mechanism, wherein the appropriate operating system command such as “emu.exe pacman.zip” is executed to initiate the next game play. In one embodiment of the present invention, a user returns to the games network interface when he or she leaves a game. And while in the network interface, the user has the option of returning to the game he or she just left, launching a new game, or receiving and viewing the default content that is associated with the network interface. Thus, one embodiment of the system provides a managed gaming experience that offers a continuous delivery of entertainment content and, as a result, the content distribution system 10 is readily distinguishable from any existing game delivery system.

The entertainment content distribution system 10, which comprises an ordered listing of selectable services can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of embodiments of the present invention in which functions may be executed out of order from that shown or discussed, including substantially concurrently or in reverse order, depending on the functionality involved, as would be understood by those reasonably skilled in the art of the present invention.

C. Exemplary System Operation

This section provides an exemplary description of how the above-described content distribution system 10 provides entertainment content to users through a plurality of graphical user interfaces. According to one embodiment of the invention, when a user initially opens the system application, the system 10 displays a two-dimensional GUI dialog box for receiving login information from the user. As shown in FIG. 11, which illustrates an embodiment of the login interface 1001, if the user has not yet subscribed to the system 10, the login interface 1001 prompts the user to sign up for a free trial period to use the system 10. If a free trial period is not being offered by the system 10, the login interface prompts the user to sign up for a subscription. The process of setting up a new account is discussed above in relation to FIG. 6. If the user has already subscribed to the system, the user enters his or her user identification and password into the interface 1001, and the GUI manager 80 sends the user identification and password to the asset protection manager 70 for verification. The process of communicating the login information to the asset protection manager 70 is discussed in further detail above in relation to FIG. 5.

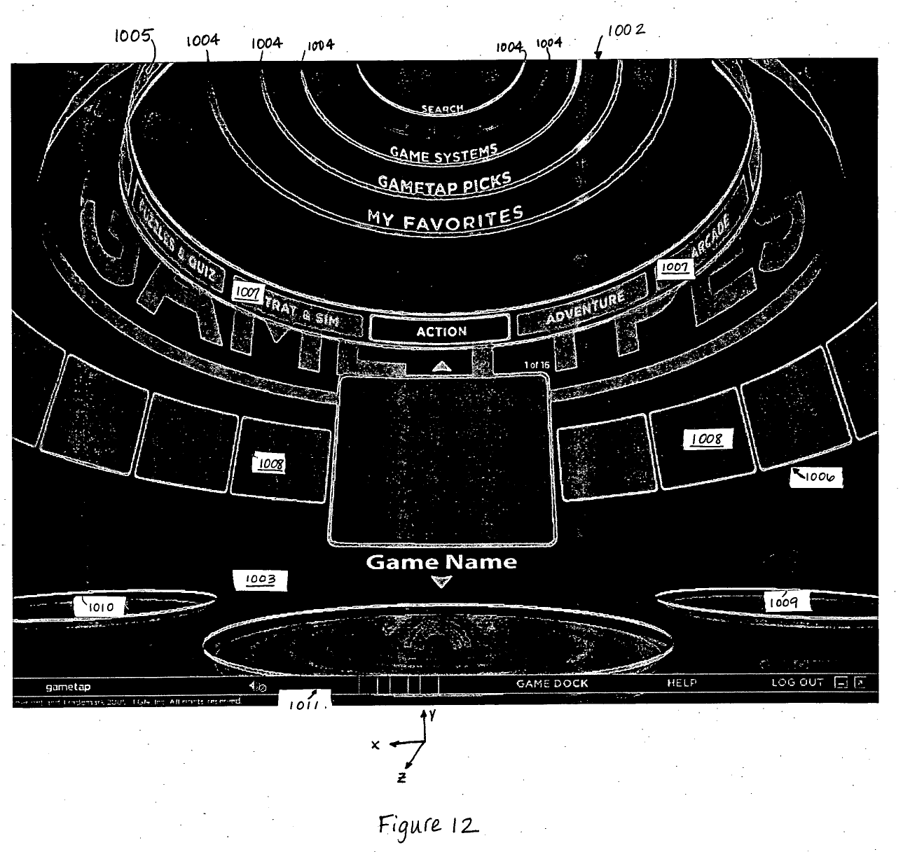

Upon verifying the user identification and password, the system 10 displays a main GUI window that serves as a hub for accessing other graphical user interface windows or dialog boxes and provides the user with tools to search for and request games. An embodiment of the main GUI window 1002 is shown in FIG. 12. This embodiment is a three-dimensional computer-generated space 1003 having an x-axis that extends horizontally across a screen, a y-axis that extends vertically across the screen, and a z-axis that extends perpendicular to the x-axis and y-axis. The space 1003 appears as a room to the user, and the viewpoint of the user is from the center of the room, thereby allowing the user to pan around the room. One embodiment of the space 1003 includes a plurality of rings, and each ring represents a particular search criteria. Upon selection of one of the rings, the system will display the content that meets the search criteria that corresponds to the selected ring. For example, in the embodiment shown in FIG. 12, the space 1003 includes a plurality of upper rings 1004 that each represent a particular search categories, an intermediate ring 1005 that is divided into a plurality of sections 1007 that each represent a sub-category of search criteria based on the type of search selected from the plurality of upper rings 1004, and a lower ring 1006 that is divided into a plurality of sections 1008 that each represent the games available based on the search criteria chosen. The rings shown are circular shaped, but other embodiments in which the rings include angled segments, such as rectangular shaped or trapezoidal shaped rings, are within the scope of the invention. Furthermore, the space 1003 includes an icon 1010 that serves as a link to a GUI environment for managing account settings and an icon 1009 that serves as a link to a GUI that provides media and entertainment content. In addition to the space 1003, the window 1002 further includes a tool bar 1011 that includes the identity of the user logged into the system, links to chat rooms and chat room updates, a link to a help file or online help service, and a logout button.

The rings 1004, 1005, 1006 appear to have a center axis of rotation along the y-axis, and the rings 1004, 1005, 1006 appear to extend through planes perpendicular to the y-axis. In a further embodiment, the rings 1004, 1005, 1006 have varying thickness and diameters, with the lower ring 1006 being thickest ring and having the greatest diameter and the upper most ring 1004 being the thinnest ring and having the smallest diameter, which causes the appearance that the upper rings 1004 are further away from the user and the lower ring 1006 is closest to the user.

Each of the plurality of upper rings 1004 represents a category by which the user can browse available games offered by the system 10. For example, users can set up a custom search, search by the type of system on which the game was originally released, search by the genre of game, search by games that are a favorite among all system users, or search by games that are selected as a favorite by the user logged into the system. These searches are represented by the following titles in FIG. 12, respectively: “Search,” “Game Types,” “Game Systems,” “GameTap™ Picks,” or “My Favorites.”

The intermediate ring 1005 typically displays sub-categories of search criteria, based on the type of search selected from the upper rings 1004. For example, if the user chooses to search by game genre, each of the sections 1007 of the intermediate ring 1005 represent a different genre, such as action games, adventure games, strat and sim games, and puzzles and quizzes. In another example, if the user chooses to search by game type, each of the sections 1007 of the intermediate ring 1005 represent a different game type, such as PC games, console games, and arcade games. If the search criteria chosen by the user does not include sub-categories, the intermediate ring 1005 may not be displayed on the screen, or it may be displayed and include alternative material instead of sub-category sections 1007.

The lower ring 1006 includes sections 1008 that represent each of the search results. The search results can be represented by text, a screen shot of the game, or both. In one embodiment, the sections 1008 display a screen shot from each game returned in the search. When a user places the cursor over the particular screen shot, the screen shot is highlighted. In a further embodiment, the screen shot enlarges, causing it to appear to move forward, or towards the user, in the z-axis direction, and the name of the game appears below the screen shot.

To pan the space 1003 and scroll through the search options, the user moves the cursor in the direction that the user wants to scroll, causing the space 1003 to rotate about the x-axis or the y-axis. To pan up or down within the three-dimensional space 1003, the user moves the cursor or the up or down arrow keys, causing the space 1003 to rotate about the x-axis. To pan left or right within the space 1003, the user moves the cursor or the right or left arrow keys, causing the space 1003 to rotate about the y-axis. To scroll between and select search criteria, the user can position the cursor over the upper rings 1004 and move the cursor up or down, such as with a mouse or with up or down arrow keys. To select a particular search criteria, the user can click on the ring representing the search criteria or hit the enter key when the ring representing the search criteria is highlighted by the cursor position. After selecting the search criteria, the user moves the cursor to the right or left over the intermediate 1005 or lower ring 1006 to scroll through the sections 1007, 1008 of the intermediate 1005 and lower rings 1006. The cursor can be moved by the mouse or by using the right or left arrow keys, for example.

When the user is ready to select a game or view information about a particular game, the user selects the section 1008 shown in the lower belt 1006 that represents the particular game. The user can use the mouse to click on the section 1008 representing the particular game, or the user can hit the enter key when the section 1008 representing the particular game is highlighted.

Upon selecting a game to request, a two-dimensional GUI dialog box appears in the foreground of the main three-dimensional GUI environment 1002. The two-dimensional GUI dialog box 1020, hereinafter referred to as an “InfoCard,” displays various information about the game and allows the user to send a request to the GUI manager 80 to play the game. As discussed above, the information to be displayed is stored in the metadata datastore 35.

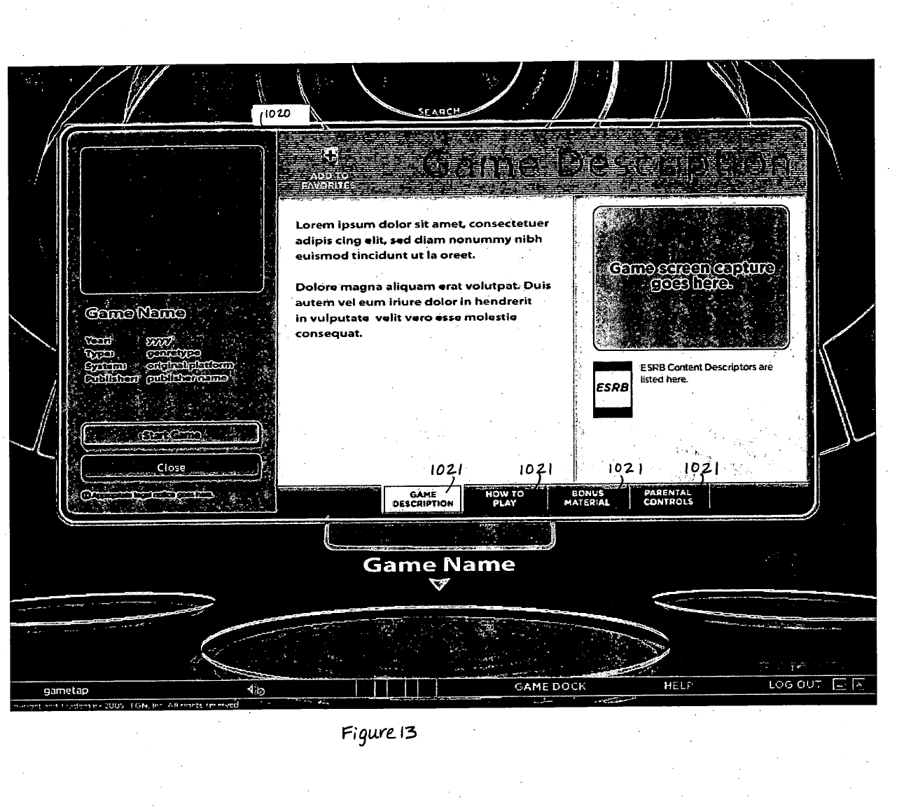

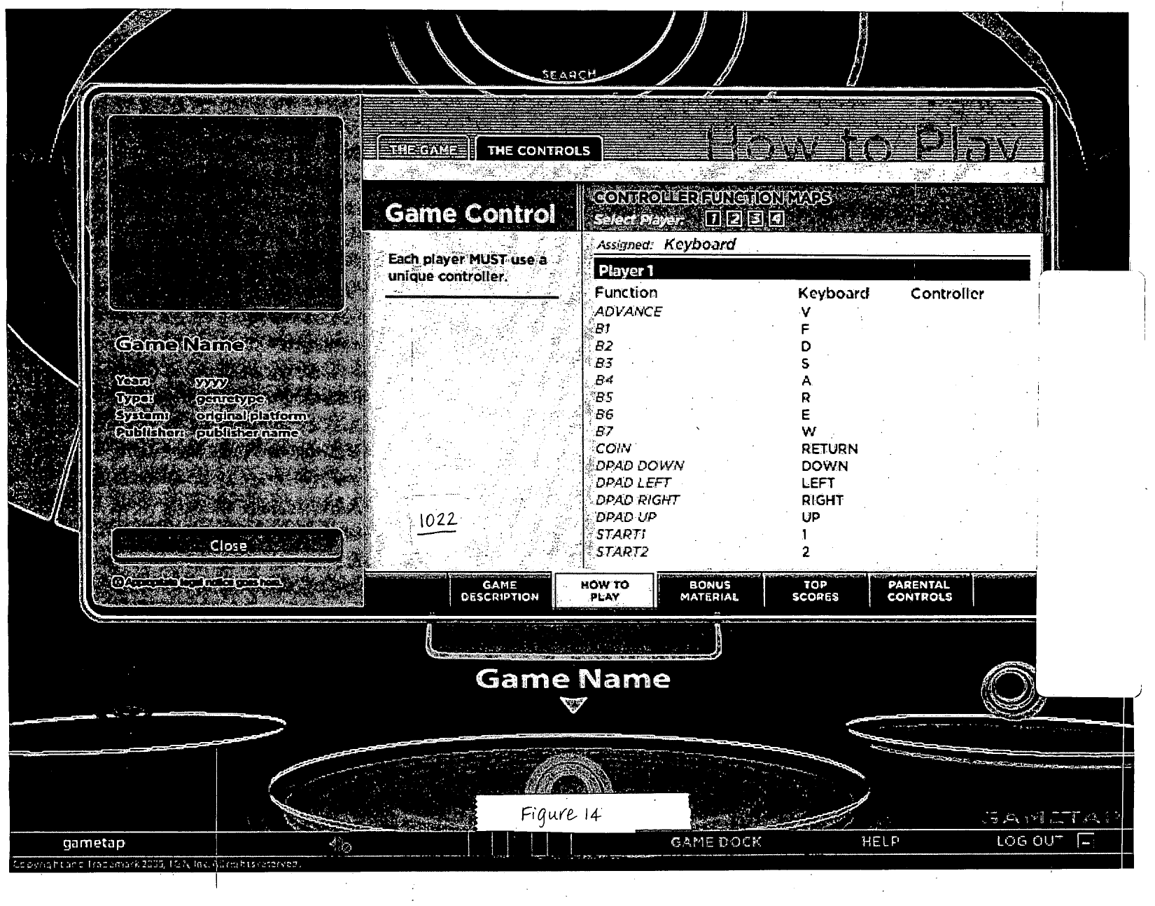

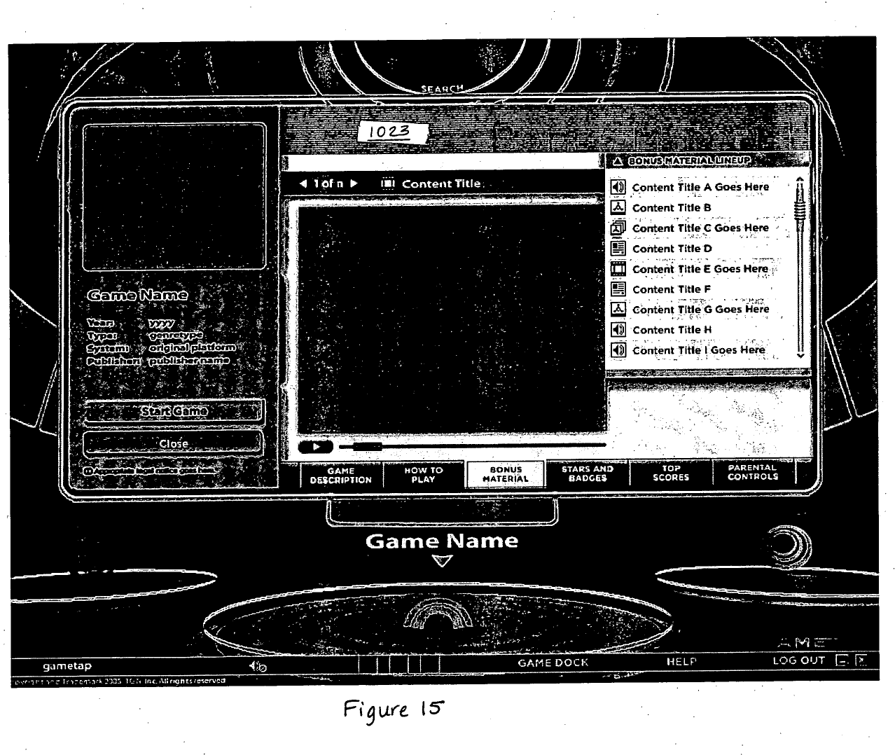

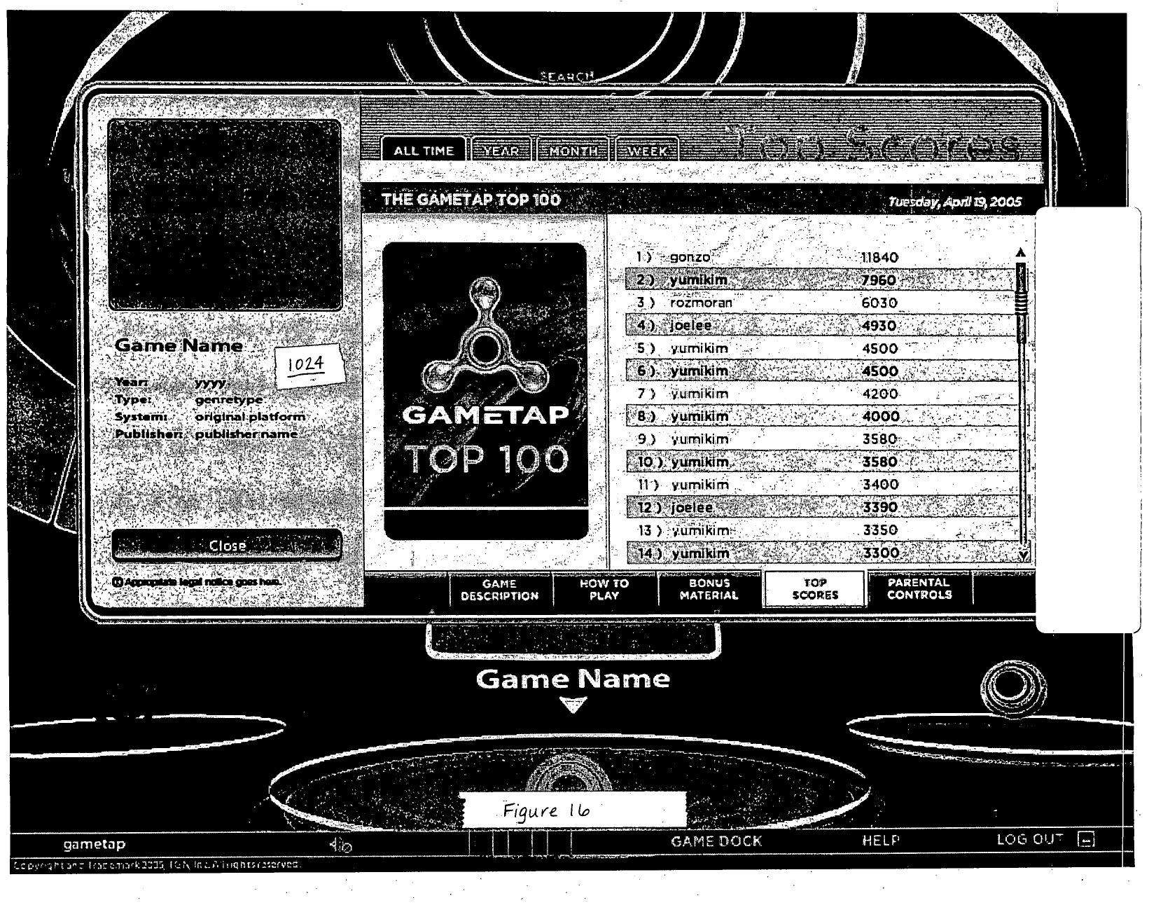

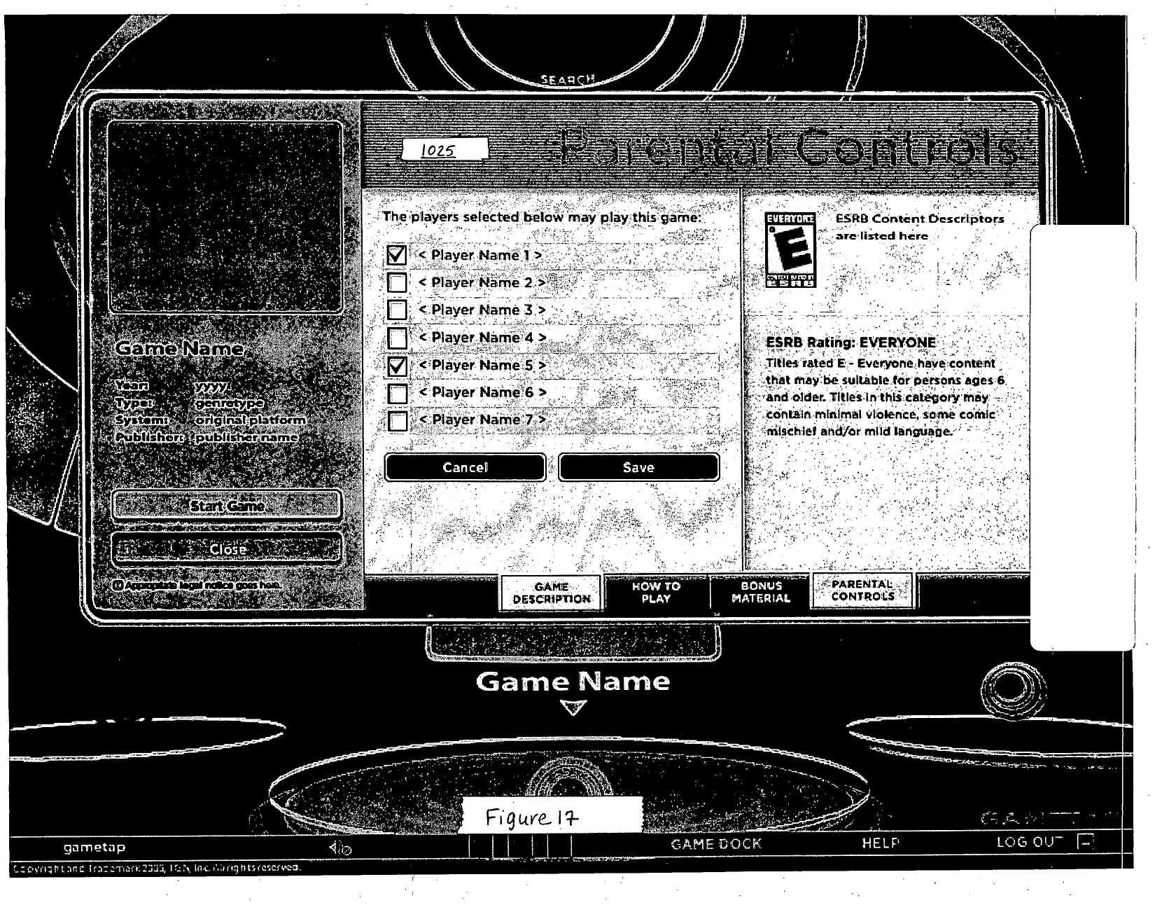

In the embodiment shown in FIGS. 13-16, the InfoCard 1020 displays the name of the game, the year the game was originally released, the system on which the game was originally released, the publisher of the game, a button for starting the game, the game's ESRB rating and content description or other parental guidance indicia, a screen capture from the game, a description of the game, helpful hints and instructions on how to play the game, user-access controls applicable to the game, top scores earned by other system users, reward or contest information related to the game, and any bonus materials that may be associated with the game. The information is grouped together and organized by tabs 1021, and to view each group of information, the user selects each corresponding tab. Alternatively, the information may be included in one dialog box. FIGS. 13-16 show examples of InfoCards 1020 that include tabs 1021 that represent various groups of information, and each of the figures displays information related to a particular tab 1021. For example, FIG. 13 shows an InfoCard 1020 displaying information associated with a “game description” tab, FIG. 14 shows an InfoCard 1022 displaying information associated with a “how to play” tab, which includes a map of the controls used for the game, FIG. 15 shows an InfoCard 1023 displaying information associated with a “bonus material” tab, which includes transitional content and helpful hints about playing the game, FIG. 16 shows an InfoCard 1024 displaying top scores by system users for the particular game, and FIG. 17 shows an InfoCard 1025 displaying the users of an account and checkboxes showing whether each user is allowed to play the game.

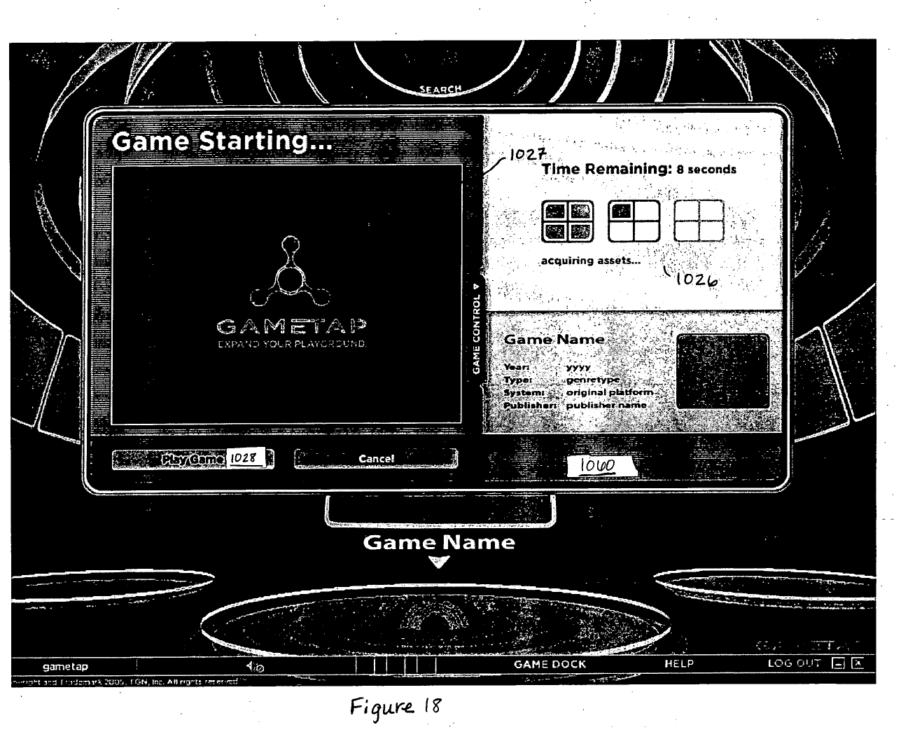

If the user selects the button that requests the game for play, a game loading interface 1060 is displayed to the user while the game is being downloaded to the user's computing device. The process of requesting and loading a game is discussed in more detail above in relation to FIG. 7. The embodiment of the game loading interface 1060 shown in FIG. 18 includes graphics 1026 that represent the progress of the download and a screen 1027 that displays transitional content while the game is being downloaded. When the game is ready for play, a “play game” button 1028 on the interface 1060 becomes active and the user can select it to end the display of the transitional content and play the game, or the user can wait and select it later to continue viewing the transitional content.

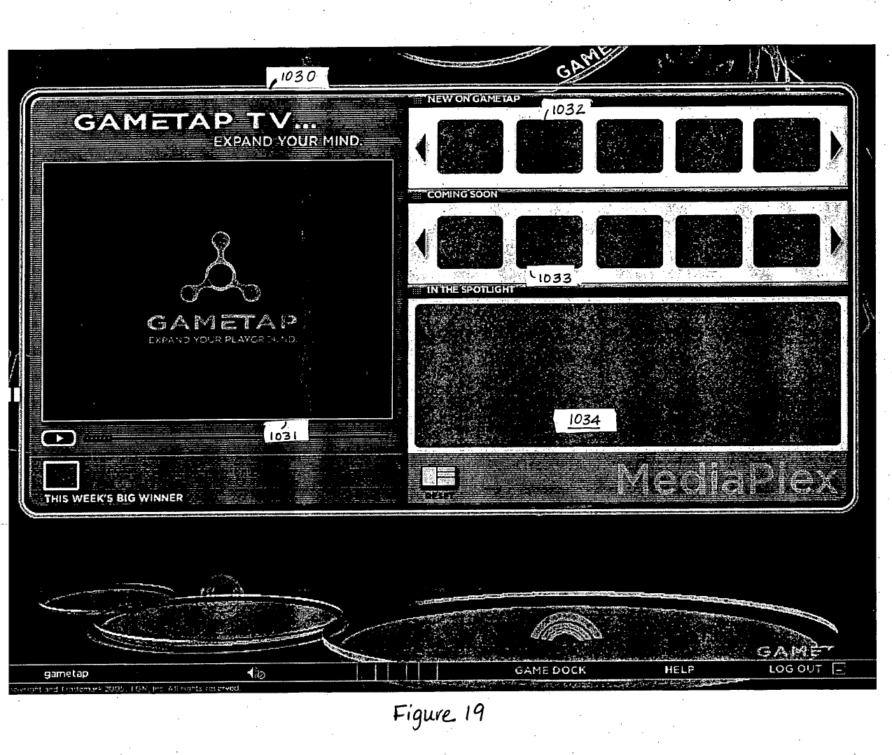

Referring back to FIG. 12, an embodiment of the three-dimensional space 1003 includes icons 1009, 1010 that provide links to an interface for accessing media or entertainment content and to an interface for managing account settings. The icon 1009 that provides a link to the entertainment content is entitled “MediaPlex,” and the icon 1010 that provides a link to the account management interface is entitled “My GameTap™.” If the user selects the MediaPlex icon 1009, a two-dimensional graphical user interface window 1030 will appear in the foreground of the main GUI environment 1002. The embodiment of the MediaPlex interface 1030 shown in FIG. 19 includes a section for displaying entertainment content 1031, a section 1032 for displaying screen shots of new games available on the system, a section 1033 for displaying games that will be supported by the system 10 in the future, and a section 1034 for displaying a game, person, or other item that is being spotlighted by the system 10. The entertainment content section 1034 can display general commercials, commercials targeted for the particular user, television shows, clips of games, or interviews of people, for example. Furthermore, the user can scroll through the sections 1032, 1033 to preview new games and games to be available in the future.

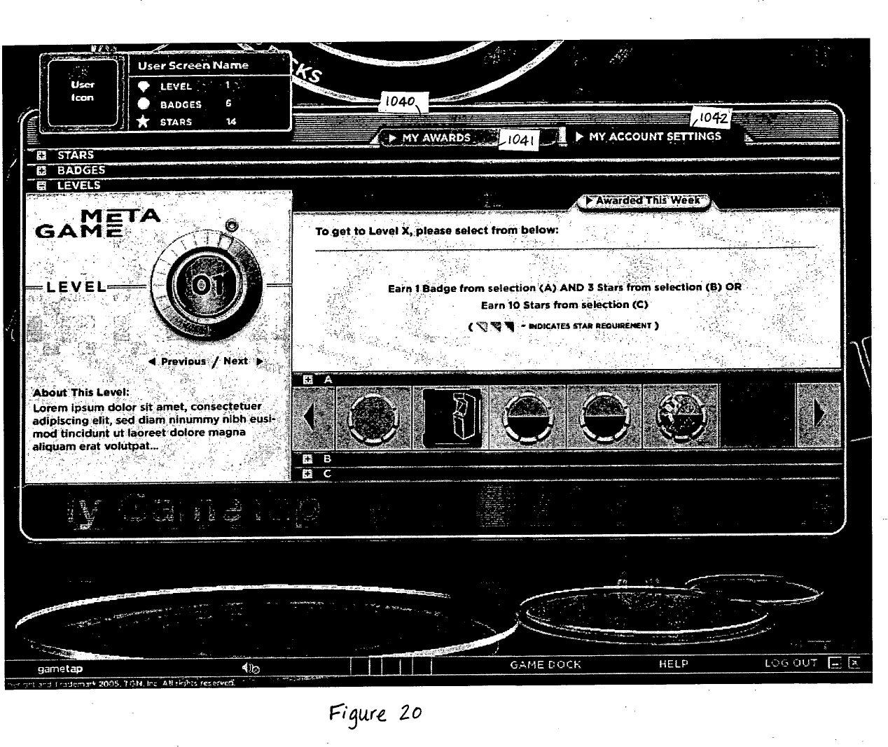

If the user selects the MyGameTap™ icon 1010, a two-dimensional GUI window 1040 is displayed in the foreground of the three-dimensional main GUI window 1002. An example of the MyGameTap™ interface 1040 is shown in FIG. 20. The interface 1040 includes one tab 1041 that displays information on award levels reached by each user and a second tab 1042 that displays account settings for the particular account.

When the account settings tab 1042 is selected, a graphical user interface window is displayed that allows the primary user or account holder to administer account settings such as payment options, choose between subscription packages, add or delete users, and set up access controls for each user. A unique feature of the present system 10 is the ability of an account holder to set up access controls on a per user basis. As shown in the exemplary interface 1050 in FIG. 21, the account holder or primary user can control a particular user's access to the different features of the system 10 by selecting a particular user and using checkboxes to select or deselect features that will be accessible by the user. For example, the primary user or account holder can lock one or more users out of the system by selecting a user identity and toggling a “lock/unlock” button; establish which games, game portions (e.g., levels), or game versions are inaccessible to each user by selecting checkboxes corresponding to a particular game, game type, game portion or game version; establish play timers for each user, limit instant messaging access for each user; disable each user's name from being displayed on leader boards; and limit each user's ability to enter contest and tournaments or enter an email address to receive updates on the system.

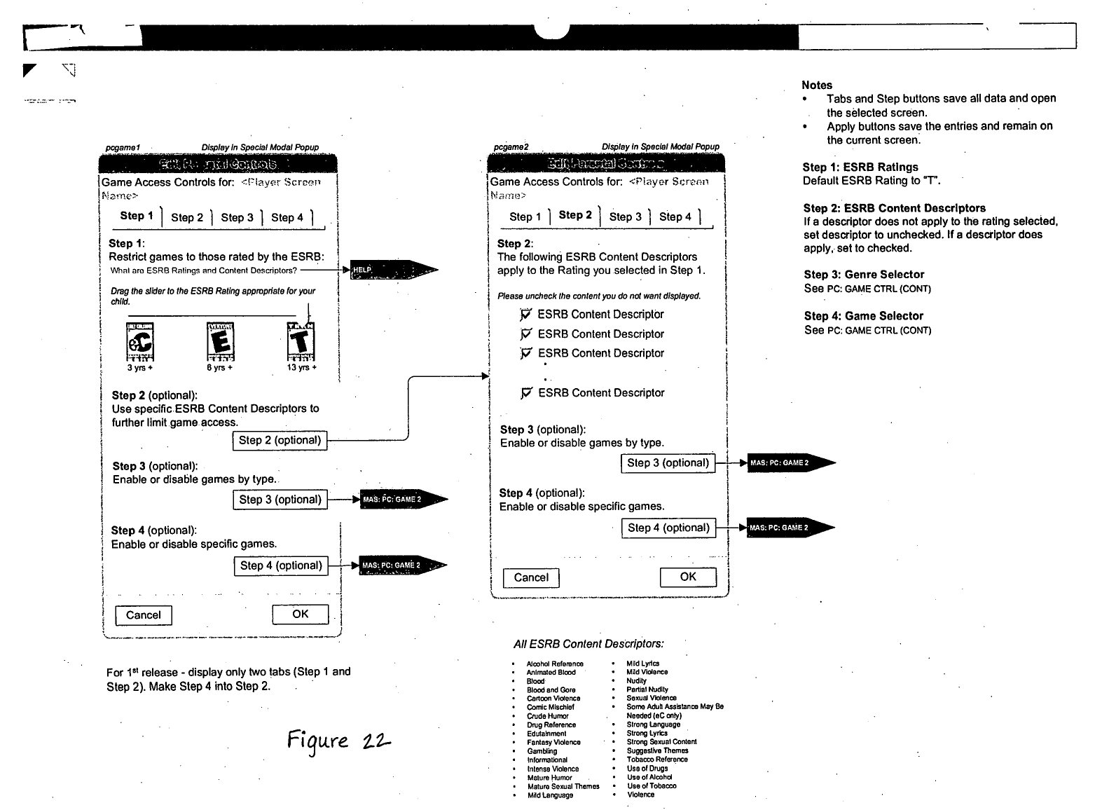

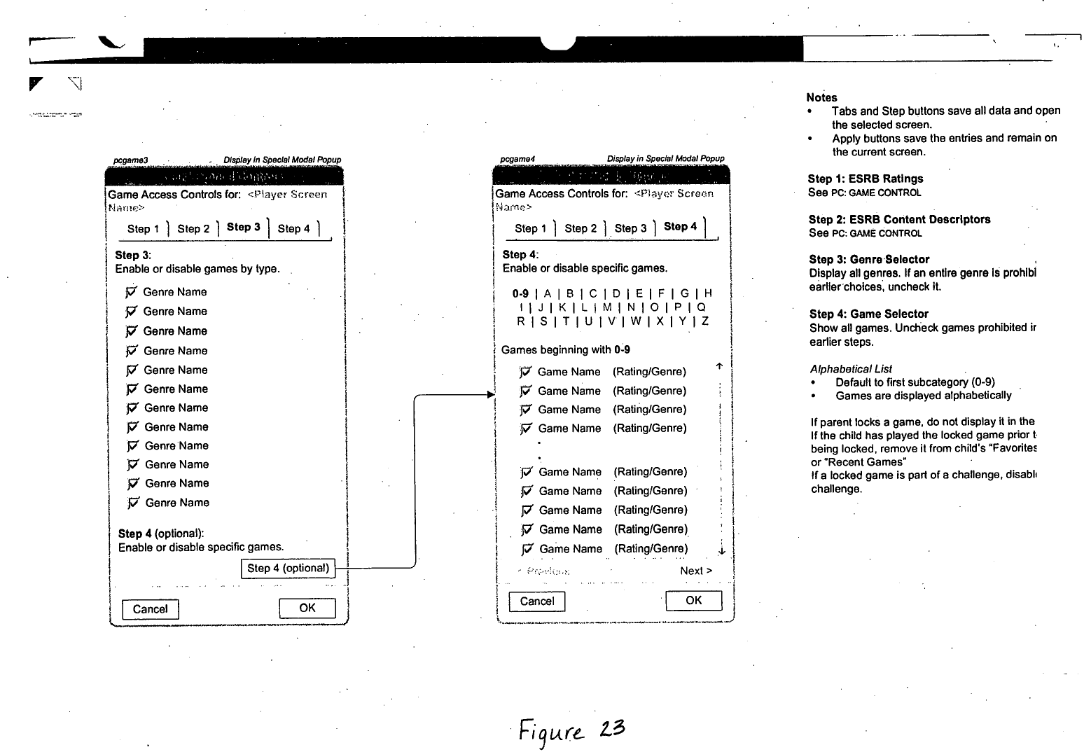

More particularly, as shown in FIGS. 22 and 23, the primary user can limit which games are accessible to the user by selecting specific games that are inaccessible to a particular user or by selecting categories of games inaccessible to the user, such as games having a particular ESRB rating, ESRB content description, or games of a certain type. In addition to publicly available parental guidance indicia such as the ESRB rating and content descriptions, the system may also provide guidance ratings or descriptions from other parties, such as the gaming system provider or a private rating system. And, as shown in FIG. 23, the primary user can limit the amount of time that the user can use the system or the times of the day, or play windows, during which the user can use the system. The daily usage time limits or play windows can be set up differently for different portions of the week, such as one set of time limits or play windows for Monday through Thursday and another set for Friday through Sunday. As an example, a parent or the primary user on the account may want to limit a user's usage of the system to two hours or less per day during weekdays and 3 hours or less per day during weekends. As another example, a parent may want to prevent a child user from using the system except during a particular time window, such as 7:00 p.m.-8:00 p.m. on weekdays and 10:00 a.m. to 12:00 p.m. on weekends. The parent or primary user can set up these limits or time windows by selecting the user to which the limitations should be applied, toggling the time limit or time window option, and entering the limits into the text boxes. Setting up time windows or time limits on a day by day basis is also contemplated.

It should also be noted that the ability to set up access controls on a per user basis can be utilized by a system administrator to set up access controls for content publishers that provide content for the system. The system administrator sets up access controls for each publisher, allowing each publisher to preview only the content belonging to the publisher, thus preventing unauthorized access to content belonging to another publisher. This feature provides security for the publishers while allowing them to preview their content as it will be presented on the system before the content is released to subscribers to the system.

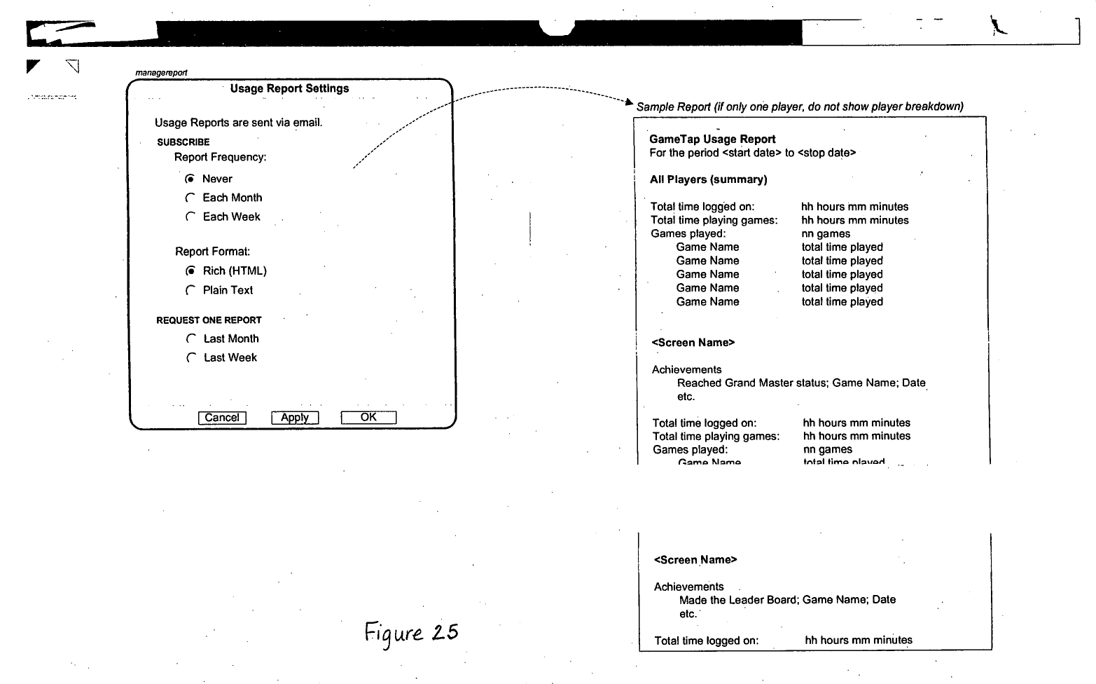

Referring to FIG. 25, the primary user can also elect to receive periodic usage reports that report the total amount of playing time by each user, a breakdown of the playing time of each user on a per game basis, the games played by each user, and the achievements of each user. In addition, the user can elect to receive the reports on a monthly or weekly basis, in HTML or rich format or in a plain text format, or request reports for previous periods. Alternatively, the primary user can opt out of receiving the reports.

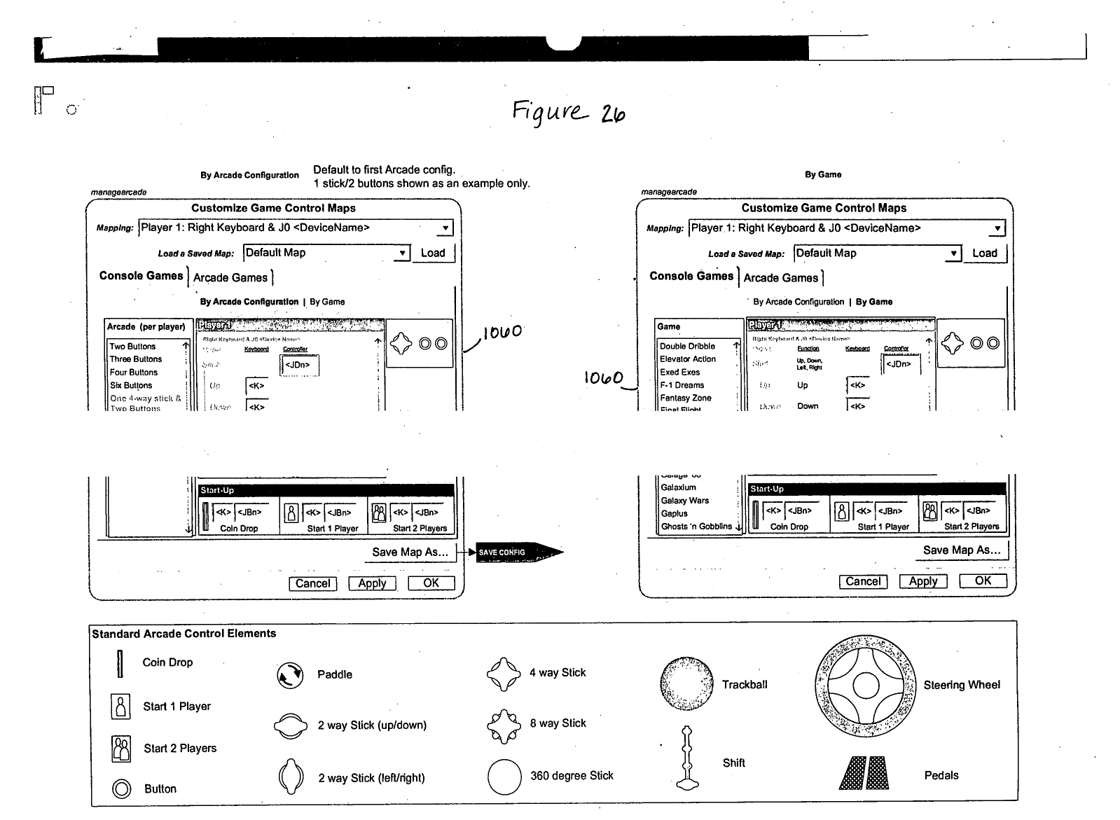

In addition to the above graphical user interfaces, the system 10 further provides each user with a graphical user interface 1060, such as the interface shown in FIG. 26, that allows a user to customize the control mapping for a particular game, based on the device used by the user. For example, if a user is playing a game that has been played with a joystick traditionally and the user is playing the game on a PC, the user can map the I, J, K, and M keys on a keyboard to correspond with the up, left, right, and down motions of a joystick, respectively, by entering the corresponding keys with the corresponding action into the interface window 1060. This mapping can be specific to a particular user for use in all games played by the user, or can be specific to a particular user for a particular game.

It should be emphasized that the above-described embodiments of the present invention are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it will be obvious to those skilled in the art that many variations and modifications can be made to the specific embodiments disclosed without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

1. A content distribution system configured for allowing at least one primary user of an account to set up access controls for one or more non-primary users of said account on a user-specific basis, said system comprising:
a client application that receives one or more access control instructions from a primary user, the access control instructions including at least one access control and an identification of a non-primary user, the access control instructions being applicable to the non-primary user; and
a memory configured for storing the access control instructions with the identification of the non-primary user,
wherein the access controls include one or more of the following restrictions: access to content, use of services, or content options.

2. A content distribution system according to claim 1, wherein said client application is capable of receiving and storing in said memory different access controls for different non-primary users.

3. A content distribution system according to claim 2, wherein the at least one access control of the first set of access control instructions is at least partially different from the at least one access control of the second set of access control instructions.

4. A content distribution system according to claim 1, wherein said client application uses access controls providing restrictions on access to content comprising one or more of the following restrictions:
access to at least a portion of selected content;
amount of time accessing content per a selected time period; or
time windows in which a user may access content.

5. A content distribution system according to claim 1, wherein said client application uses access controls providing restrictions on use of services comprising one or more of the following restrictions:
access to instant messaging services;
display of a user's name on the system to other users;
access to message boards; and
receipt of a user's email address into the system.

6. A content distribution system according to claim 1, wherein said client application uses access controls providing restrictions on content options comprising one or more of restrictions on entrance of a user into tournaments, contests, or sweepstakes to earn rewards.

7. A content distribution system configured for allowing at least one primary user of an account to set up access controls for one or more non-primary users of the account on a user-specific basis, said system comprising:
a client application that receives one or more access control instructions from a primary user, the access control instructions including at least one access control and an identification of a non-primary user, the access control instructions being applicable to the non-primary user; and
a memory configured for storing the access control instructions with the identification of the non-primary user,
wherein the access controls are a time restriction.

8. A content distribution system according to claim 7, wherein the access controls are a limitation on the amount of time allowed for accessing content per a selected time period.

9. A content distribution system according to claim 7, wherein the access controls are a limitation to selected time windows in which a user may access content.

10-18. (canceled)

19. A content distribution system configured for automatically identifying content units to be updated and updating the content units, said system comprising:
an end-user computing device having stored thereon content comprised of content units for various content types, the content types including games, metadata, media content, and software programs;
one or more servers in communication with said end-user computing device over a network said one or more servers storing at least one updated content unit for distribution to said end-user computing device and an updating module; and
an updating module, said updating module configured for comparing at least one content unit stored on said end-user computing device to a representative updated content unit stored on said one or more servers and identifying whether the content unit on said end-user computing device matches the representative updated content unit stored on said one or more servers,
wherein said updating module is further configured for distributing updated content units to said end-user computing device in incremental units, the incremental units being selected from the group consisting of a data block of a selected optimal size, a group of data blocks, a group of selected files, and a directory tree of files.

20. A content distribution system according to claim 19 wherein the content units are selected from the group consisting of: simple files, binary data blocks, structured file sets, and data block sets.

21. A content distribution system according to claim 19, wherein said updating module organizes and optimizes distribution of the updated content units stored on said one or more servers based on a content unit type, the content unit type selected from the group consisting of: memory-only content units, startup content units, progressive content units, predictive content units, and on-demand content units.

22. A content distribution system according to claim 19 wherein said one or more servers includes a plurality of servers, the plurality of servers being used in sequence or in parallel to retrieve different segments of updated content units at different times.

23. A content distribution system according to claim 19 wherein said client application uses a stateless protocol to receive updated content units from said one or more servers.

24. A content distribution system according to claim 23 wherein the stateless protocol is selected from the group consisting of HTTP and TCP/IP.

25. A content distribution system according to claim 19 wherein said client application uses a stateless protocol to retrieve updated content data units from a relay network system.

26. A content distribution system according to claim 25 wherein the stateless protocol is P2P.

27. A content distribution system comprising:
a client application for managing content and presenting the content on an end-user computing device, said client application configured to implement a unified virtual disk volume scheme on the end-user computing device; and
one or more servers, wherein data is transferred from said one or more servers to the end-user computing device and stored using the unified virtual disk volume scheme,
wherein the virtual disk volume scheme includes an arbitrary set of encrypted viral disk volumes implemented on the end-user computing device, the encrypted virtual disk volumes configured to store data of a specific type and secure the data from unauthorized access, and the content type being selected from a group consisting of games, software programs, metadata, and media content.

28. A content distribution system according to claim 27, wherein said client application is configured for accessing each virtual disk volume simultaneously or individually at any time during a client application session.

29. A content distribution system according to claim 27, wherein the arbitrary set of encrypted virtual disk volumes is created on the end-user computing device as needed for local storage.

30. A content distribution system according to claim 27, wherein the virtual disk volume scheme secures specific types of content using one of the following methods: alternative key generation methods, methods for retrieving and storing a key or methods for varying key sizes and protocols.

31. A content distribution system according to claim 30 wherein said client application obtains a content key to access encrypted content stored on a virtual disk volume using the following sequence:
predetermining a server public key that is known to said client application and a key server;
generating a session public key and a session private key for each client session, the session public key being different from the session private key;
sending an encrypted request from said client application to the key server requesting the content key for a particular game, said request including a first random number, an identifier associated with the particular content, and the session public key, wherein the request is encrypted using the server public key;
receiving an encrypted response from the server, the response including the content key and a second random number, wherein the response is encrypted by the key server using the session public key; and
extracting and decrypting the content key from the response using the server public key and the session private key.

32. A content distribution system according to claim 31 wherein said client application accesses a plurality of games, media content, and metadata from the set of virtual disk volumes using a direct application program interface (API) or the end-user computing device virtual disk device driver.

33. A content distribution system according to claim 31 wherein access to the plurality of games, media content, and metadata includes reading, writing, updating, and deleting.

34. A content distribution system according to claim 27, wherein a virtual disk manager uses a single user-device resident device driver to control access to the plurality of virtual disk volumes.

35. A content distribution system according to claim 27, wherein said client application dynamically loads and unloads a memory-resident virtual disk driver each time said client application is started and shutdown.

36. A content distribution system according to claim 27 wherein the virtual disk volumes can be accessed by a name that includes various characters.

37. A content distribution system according to claim 27 wherein each virtual disk volume is associated with metadata, the metadata includes a status and attributes of each virtual disk volume.

38. A content distribution system according to claim 27 wherein the data stored within the virtual disk volume is capable of being re-encrypted within said client application without the need to re-encrypt and redownload data from the server.

39. A content distribution system according to claim 27 wherein each virtual disk volume is capable of being distributed on one or more physical storage devices on the end-user computing device.

40. A system for securing a software program between uses, said system comprising:
a memory including a software program, the software program stored in said memory in a plurality of content units, each content unit comprising a subset of the software program; and
a processing element configured for analyzing the content units to identify critical content units of the software program and causing at least one of the critical content units to become inoperable when the software program is not in use,
wherein the critical content units include content units that are required for running at least a portion of the software program.

41. A system according to claim 40, wherein said processing element causes the critical content units to become inoperable by deleting at least a portion of the critical content units when the software program is not in use.

42. A system according to claim 40, wherein said processing element causes the critical content units to become inoperable by corrupting at least a portion of the critical content units when the software program is not in use.

43. A system according to claim 40, wherein in response to a subsequent request to use the software program, said processing element restores one or more of the critical content units that was made inoperable.

44. A system according to claim 40, wherein in response to a subsequent request to use the software program, said processing element identifies one or more of the critical content units that was made inoperable and replaces the critical content units with operable critical content units.

45. A system for securing a software program between uses comprising:
a software program divided into a plurality of content units, each content unit comprising a subset of the software program, said software program comprising a plurality of non-critical content units and a plurality of critical content units, wherein the critical content units are required for operating at least a portion of the software program;
a memory for storing said software program; and
a processing element configured for removing or corrupting at least one of the critical content units stored in said memory when said software program is not in use,
wherein, in response to a subsequent request to use said software program, the processing element identifies at least one of the critical content units that was one of removed or corrupted and corrects the critical content unit.

46. A game delivery system for saving game play progress for one or more users in response to the users pausing or terminating game play, said system configured for:
receiving instructions from a user to pause or terminate game play for a game;
in response to receiving the instructions, associating a game play progress point corresponding to play progress in the game with an identification of the user; and
storing the game play progress point and the identification of the user in a memory.

47. A game delivery system according to claim 46, wherein said system is further configured for, in response to the user subsequently requesting game play of the game, resuming game play of the game for the user at the game play progress point.

48. A game delivery system according to claim 47, wherein the system is further configured for storing game play progress points for different users and, in response to each user subsequently requesting game play of the game, resuming game play of the game for each user at the game play progress point associated with the user.

49. A game delivery system according to claim 48, wherein the game is a game originally played on an arcade platform.

50. A game delivery system that allows a user to select from a plurality of games and receive delivery of at least one of the plurality of games via a network, the plurality of games including a first set of game software stored in a format able to be executed on one or more arcade game systems, a second set of game software stored in a format able to be executed on a video game console systems, a third set of game software stored in a format able to be executed on a personal computer, and a fourth set of game software stored in a format able to be executed on a general computing device, said system comprising:
an asset server that stores software game code associated with said plurality of games;
a host server that directs said asset server to deliver one of said plurality of games to an end-user computing device associated with said user in response to a request from said user; and
a client application that resides on said end-user computing device and is configured to display a list of available games and to accept from said user said request to play a game,
wherein:
said one delivered game is delivered via said network to the end-user computing device;
said client application is configured to transmit said request to said host server and to receive said software game code from said asset server in response to said request; and
said client application comprises a plurality of game players, at least one of said game players including an emulator that is configured to translate original platform machine code blocks to functionally equivalent blocks of compiled instruction set code on a target platform.

51. A game delivery system according to claim 50 wherein at least one of said emulators is further configured to interpret original platform machine code blocks as functionally equivalent blocks of compiled instruction set code on the target platform.

52. A game delivery system according to claim 50 wherein said emulators rely upon a graphical engine that supports three-dimensional graphics.

53. A game delivery system according to claim 50 wherein said client application supports simultaneous downloading of content and display of a video.

54. A game delivery system according to claim 50 wherein said client application supports the simultaneous downloading of a first game and play of a second game.

55. A game delivery system according to claim 50 wherein said client application is configured for assessing the hardware and software capabilities of an end-user computing device and adjusting aspects of a graphical user interface downloaded to the end-user computing device.

56. A game delivery system according to claim 50 wherein the aspects include performance, effects, resolution and quality.

57. A game delivery system according to claim 50 wherein said client application is further configured for supporting instant messaging payloads, the instant messaging payloads including screen shots and challenges.

58. A game delivery system according to claim 50 wherein said client application is configured to integrate media, games, linear TV, and interactive TV into a single environment and run on a set top box or general purpose computing device.

59. A content distribution system configured for allowing a system administrator to set up access controls for one or more content publishers on a publisher-specific basis, said system comprising:
a client application that receives one or more access control instructions from the system administrator, the access control instructions including at least one access control and an identification of a content publisher, the access control instructions being applicable to the content publisher; and
a memory configured for storing the access control instructions with the identification of the content publisher,
wherein the access controls allow the content publisher to preview the content provided by the content publisher and prevent the content publisher from previewing content provided by another content publisher.

60. A system for securing a software program between uses, said system comprising:
a processing element configured for analyzing content units of a software program to identify critical content units of the software program, each content unit comprising a subset of the software program,
said processing element further configured for directing at least one critical content unit to be stored in a temporary memory and non-critical content units to be stored in a persistent memory, the temporary memory configured to lose the at least one critical content unit when the software program is not in use,
wherein the critical content units include content units that are required for running at least a portion of the software program.
